(19) United States
(12) Patent Application Publication
(10) Pub. No.: US 2025/0076739 A1
(43) Pub. Date: Mar. 6, 2025

(54) LENS DRIVING DEVICE AND CAMERA MODULE

(71) Applicant: ALPS ALPINE CO., LTD., Tokyo (JP)

(72) Inventors: Masanobu MAEDA, Niigata (JP); Changxing WANG, Miyagi (JP)

(21) Appl. No.: 18/819,314

(22) Filed: Aug. 29, 2024

(30) Foreign Application Priority Data
Sep. 1, 2023 (JP) 2023-141930

(51) Int. Cl. G03B 13/36; G03B 5/00

(52) U.S. Cl. CPC G03B 13/36; G03B 5/00; G03B 2205/0076

(57) ABSTRACT

A lens driving device includes a fixed member including a base member; a lens holder including a cylindrical portion configured to hold a lens body; and a plurality of shape memory alloy wires configured to move the lens holder with respect to the fixed member. The fixed member includes a fixed contact that forms a stopper configured to restrict movement of the lens holder. The lens holder includes an elastic portion formed of a material that is softer than that of a synthetic resin material forming the cylindrical portion of the lens holder. The elastic portion includes a movable contact that faces the fixed contact of the stopper so as to be able to contact the fixed contact of the stopper.

### CROSS-REFERENCE TO RELATED APPLICATIONS

The present application is based on and claims priority to Japanese Patent Application No. 2023-141930 filed on Sep. 1, 2023, the entire contents of which are hereby incorporated by reference.

### BACKGROUND

### 1. Field of the Invention

The present disclosure relates to lens driving devices.

### 2. Description of the Related Art

A lens driving device configured to move a lens holder by a shape memory alloy wire is known in Japanese Laid-Open Patent Application No. 2022-074138.

### SUMMARY

A lens driving device according to an embodiment of the present disclosure includes: a fixed member including a base member; a lens holder including a cylindrical portion configured to hold a lens body; and a plurality of shape memory alloy wires configured to move the lens holder with respect to the fixed member. The fixed member includes a fixed contact that forms a stopper configured to restrict movement of the lens holder. The lens holder includes an elastic portion formed of a material that is softer than that of a synthetic resin material forming the cylindrical portion of the lens holder. The elastic portion includes a movable contact that faces the fixed contact of the stopper so as to be able to contact the fixed contact of the stopper.

### BRIEF DESCRIPTION OF THE DRAWINGS

FIG. 1 is a perspective view of a lens driving device;

FIG. 2 is an exploded perspective view of a lens driving device;

FIG. 3 is a perspective view of a metal member connected to a lens holder and a base member;

FIG. 4 is a view of a metal member to which shape memory alloy wires are attached;

FIG. 5 is a perspective view of the base member;

FIG. 6 is a view illustrating a positional relationship between a leaf spring, the shape memory alloy wires, the metal member, and a conductive member;

FIG. 7 is a top view of the leaf spring and the metal member;

FIG. 8 is a view illustrating an example of a connection structure configured to connect the fixed metal member and the conductive member;

FIG. 9 is a perspective view of a spacer, the lens holder, an upper cover, and the base member;

FIG. 10 is perspective and top views of the conductive member;

FIG. 11 is a detailed view of the lens holder;

FIG. 12 is a perspective view of an elastic portion and the lens holder;

FIG. 13 is a top view of the lens holder and the base member to which the elastic portion and a first magnetic member are attached;

FIG. 14 is a vertical cross-sectional view of the lens holder, the elastic portion, the first magnetic member, the base member, and the conductive member;

FIG. 15 is a vertical cross-sectional view of the lens holder, the elastic portion, the base member, and the conductive member;

FIG. 16 is a transverse cross-sectional view of the lens holder, the elastic portion, the first magnetic member, the base member, and the conductive member; and

FIG. 17 is a top view of the base member and the lens holder to which the elastic portion and the first magnetic member are attached.

### DETAILED DESCRIPTION OF THE DISCLOSURE

The lens driving device disclosed in Japanese Laid-Open Patent Application No. 2022-074138 includes a spacer disposed on the upper side of the lens holder. The spacer and the lens holder form a stopper configured to restrict excessive upward movement of the lens holder.

Therefore, when the lens holder is moved and contacted with the spacer by application of vibration or the like to the lens driving device, a contact sound may be generated.

Thus, it is desirable to provide a lens driving device configured to suppress generation of a sound at the stopper.

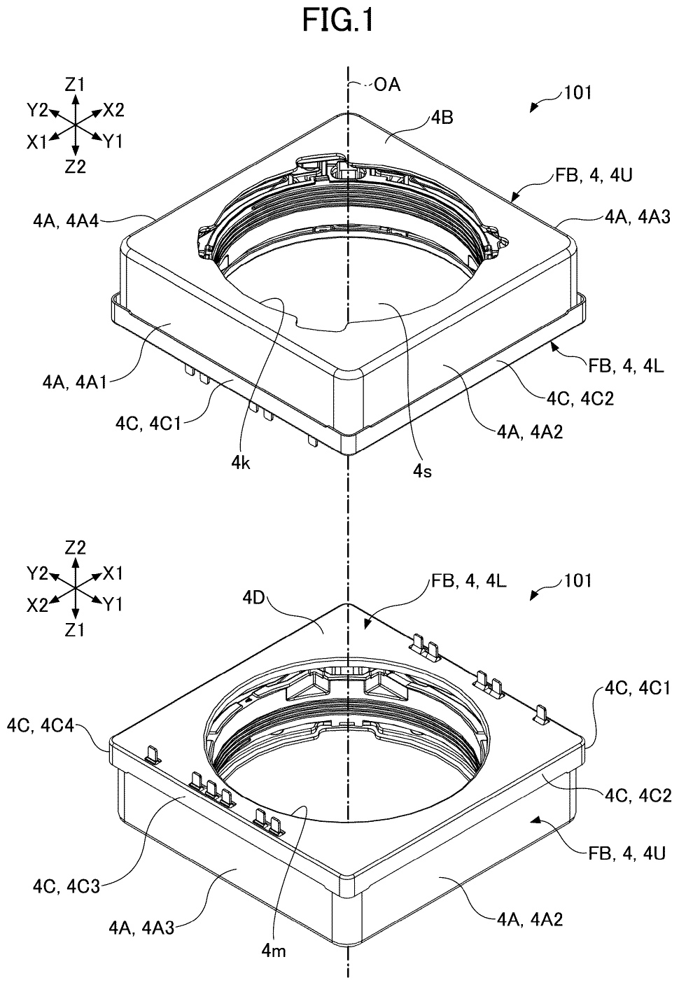

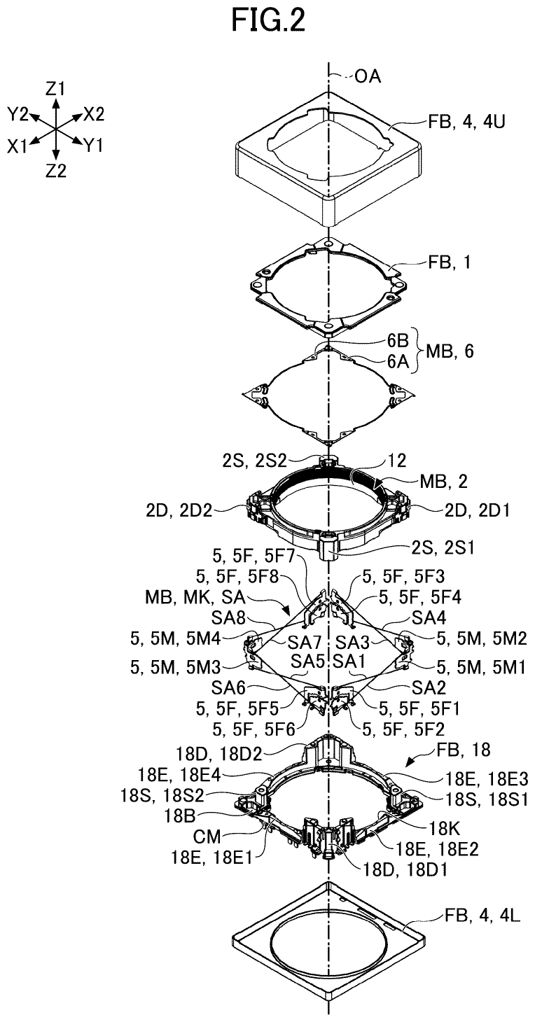

A lens driving device 101 according to an embodiment of the present disclosure will now be described with reference to the drawings. FIG. 1 is a perspective view of the lens driving device 101. Specifically, the upper view of FIG. 1 is an upper perspective view of the lens driving device 101, and the lower view of FIG. 1 is a lower perspective view of the lens driving device 101. FIG. 2 is an exploded perspective view of the lens driving device 101.

In FIGS. 1 and 2, X1 denotes one direction of an X-axis forming a three-dimensional orthogonal coordinate system, and X2 denotes the other direction of the X-axis. Y1 denotes one direction of a Y-axis forming the three-dimensional orthogonal coordinate system, and Y2 denotes the other direction of the Y-axis. Similarly, Z1 denotes one direction of a Z-axis forming the three-dimensional orthogonal coordinate system, and Z2 denotes the other direction of the Z-axis. In FIGS. 1 and 2, an X1-side of the lens driving device 101 corresponds to a forward side (front surface side) of the lens driving device 101, and an X2-side of the lens driving device 101 corresponds to a rearward side (rear surface side) of the lens driving device 101. A Y1-side of the lens driving device 101 corresponds to a right side of the lens driving device 101, and a Y2-side of the lens driving device 101 corresponds to a left side of the lens driving device 101. A Z1-side of the lens driving device 101 corresponds to an upper side (subject side) of the lens driving device 101, and a Z2-side of the lens driving device 101 corresponds to a lower side (imaging element side) of the lens driving device 101. The same applies in the other drawings.

As illustrated in FIGS. 1 and 2, the lens driving device 101 includes a cover member 4 that is a part of a fixed member FB. The cover member 4 includes an upper cover member 4U and a lower cover member 4L.

The cover member 4 is configured to function as a casing that covers the members. In the present embodiment, the cover member 4 is formed of a non-magnetic metal. However, the cover member 4 may be formed of a magnetic metal. The cover member 4 has a box-like outer shape that defines a housing portion 4s as illustrated in FIG. 1.

The upper cover member 4U includes: a first outer peripheral wall 4A that is rectangular and cylindrical; and an upper plate 4B that is provided so as to be continuous with an upper end of the first outer peripheral wall 4A (Z1-side end) and is rectangular and flat. A circular opening 4k is formed at the center of the upper plate 4B. The first outer peripheral wall 4A includes a first side plate 4A1 to a fourth side plate 4A4. The first side plate 4A1 and the third side plate 4A3 face each other, and the second side plate 4A2 and the fourth side plate 4A4 face each other. The first side plate 4A1 and the third side plate 4A3 extend perpendicular to the second side plate 4A2 and the fourth side plate 4A4.

Similarly, the lower cover member 4L includes: a second outer peripheral wall 4C that is rectangular and cylindrical; and a lower plate 4D that is provided so as to be continuous with a lower end of the second outer peripheral wall 4C (Z2-side end) and is rectangular and flat. A circular opening 4m is formed at the center of the lower plate 4D. The second outer peripheral wall 4C includes a first side plate 4C1 to a fourth side plate 4C4. The first side plate 4C1 and the third side plate 4C3 face each other, and the second side plate 4C2 and the fourth side plate 4C4 face each other. The first side plate 4C1 and the third side plate 4C3 extend perpendicular to the second side plate 4C2 and the fourth side plate 4C4.

As illustrated in FIG. 1, the upper cover member 4U is bonded to the lower cover member 4L with an adhesive. The second outer peripheral wall 4C is disposed so as to partially cover the first outer peripheral wall 4A.

As illustrated in FIG. 2, the cover member 4 houses a spacer 1, a lens holder 2, a metal member 5, a leaf spring 6, a base member 18, a shape memory alloy wire SA, and the like.

A movable member MB includes: the lens holder 2 configured to hold an unillustrated lens body; the shape memory alloy wire SA serving as a driving mechanism MK configured to move the lens holder 2 along an optical axis OA of the lens body; and the leaf spring 6 configured to support the lens holder 2 so as to be movable along the optical axis OA. The lens body is, for example, a cylindrical lens barrel including at least one lens, and a center axis thereof is along the optical axis OA.

The spacer 1 is disposed so as to prevent collision between the lens holder 2 formed of a synthetic resin and the cover member 4 formed of a metal when the lens holder 2 is moved in a Z1 direction. That is, the spacer 1 is formed of a synthetic resin and is disposed so as to form a space between the lens holder 2 and the upper plate 4B of the cover member 4. The spacer 1 is fixed to the upper cover member 4U with an adhesive. Specifically, the spacer 1 and the lens holder 2 form a first stopper ST1 configured to restrict excessive movement of the lens holder 2 in the Z1 direction (upward), which is one of the stoppers ST configured to restrict excessive movement of the lens holder 2. In the present embodiment, the lens holder 2 is configured to contact the spacer 1 upon moving in the Z1 direction by a predetermined distance. With this configuration, the spacer 1 can prevent contact between the lens holder 2 formed of a synthetic resin and the upper cover member 4U formed of a metal, thereby preventing wear of the lens holder 2 caused due to such contact. However, when such a space can be formed between the lens holder 2 and the upper plate 4B of the upper cover member 4U by another structure of the like, the spacer 1 may be omitted.

The lens holder 2 is formed through injection molding of a synthetic resin, such as a liquid crystal polymer (LCP) or the like. Specifically, as illustrated in FIG. 2, the lens holder 2 includes: a cylindrical portion 12 formed so as to extend along the optical axis OA; and a movable base 2D and a projection 2S formed so as to project from the cylindrical portion 12 outward in the radial direction. In the present embodiment, the inner peripheral surface of the cylindrical portion 12 is provided with a spiral groove that is formed such that an adhesive can spread between the lens body and the inner peripheral surface of the cylindrical portion 12. The spiral groove may be omitted.

The movable base 2D includes a first movable base 2D1 and a second movable base 2D2. The first movable base 2D1 and the second movable base 2D2 are disposed to extend in opposite directions across the optical axis OA. Similarly, the projection 2S includes a first projection 2S1 and a second projection 2S2. The first projection 2S1 and the second projection 2S2 are disposed to extend in opposite directions across the optical axis OA. Specifically, the movable bases 2D and the projections 2S are disposed to correspond to the four corners of the lens holder 2 having an approximately rectangular outer shape in a top view, and are arranged alternately. A part of the leaf spring 6 is placed at each of the two movable bases 2D.

The driving mechanism MK includes the shape memory alloy wire SA that is an example of a shape memory actuator. In the present embodiment, the shape memory alloy wire SA includes a first wire SA1 to an eighth wire SA8. In response to flowing of a current, the shape memory alloy wire SA increases in temperature and shrinks as a result of the increase in temperature. By utilizing the shrinkage of the shape memory alloy wire SA, the driving mechanism MK can move the lens holder 2 upward and downward along the optical axis OA. The lens holder 2 is moved in response to shrinkage of one or more of the first wire SA1 to the eighth wire SA8 of the shape memory alloy wire SA, and the other one or more of the first wire SA1 to the eighth wire SA8 of the shape memory alloy wire SA are stretched in response to the movement of the lens holder 2.

The leaf spring 6 is configured to support the lens holder 2 so as to be movable with respect to the fixed member FB (base member 18) in the direction parallel to the optical axis OA. In the present embodiment, the leaf spring 6 is formed of a metal plate mainly formed of a copper alloy, a titanium-copper-based alloy (titanium-copper), or a copper-nickel alloy (nickel-tin-copper), or the like. Specifically, the leaf spring 6 includes a first leaf spring 6A and a second leaf spring 6B.

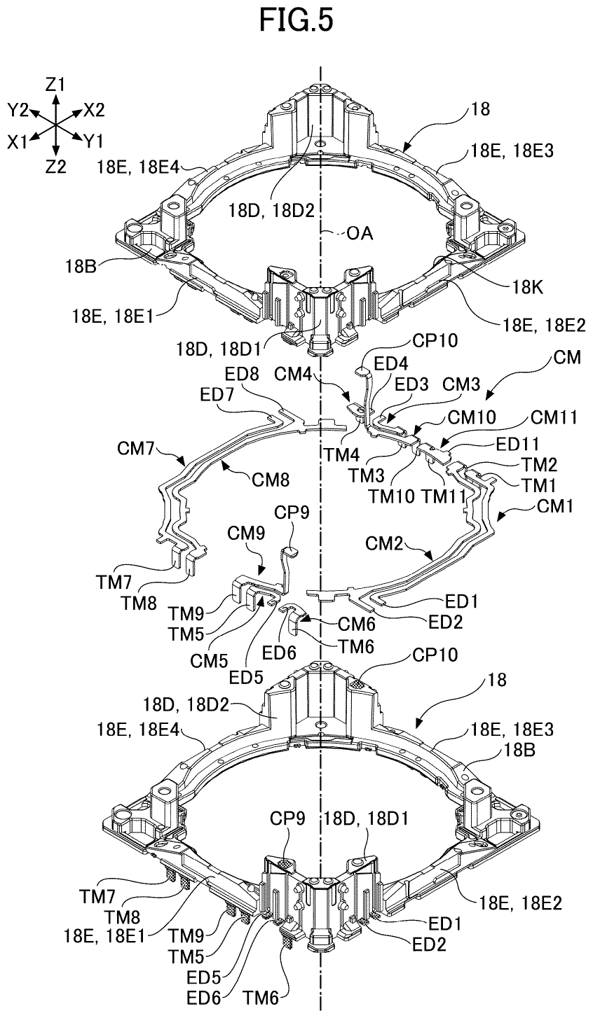

The base member 18 is formed through injection molding using a synthetic resin, such as a liquid crystal polymer (LCP) or the like. In the present embodiment, as illustrated in the upper view of FIG. 5, the base member 18 has an approximately rectangular profile in a top view, and has an opening 18K at the center thereof. Specifically, the base member 18 includes a rectangular base portion 18B disposed to enclose the opening 18K that is circular. The base portion 18B has four side portions 18E (first side portion 18E1 to fourth side portion 18E4).

The leaf spring 6 is configured to connect the movable base 2D formed in the lens holder 2 with a fixed base 18D formed in the base member 18. The fixed base 18D is a portion projecting upward from the base portion 18B of the base member 18, and includes a first fixed base 18D1 and a second fixed base 18D2.

More specifically, the first leaf spring 6A is configured to connect the first movable base 2D1 formed at the lens holder 2 with the first fixed base 18D1 and the second fixed base 18D2 that are formed at the base member 18. Similarly, the second leaf spring 6B is configured to connect the second movable base 2D2 formed at the lens holder 2 with the first fixed base 18D1 and the second fixed base 18D2 that are formed at the base member 18.

The metal member 5 is configured such that the ends of the shape memory alloy wire SA are fixed to the metal member 5. In the present embodiment, the metal member 5 is formed of a non-magnetic metal and includes a fixed metal member 5F and a movable metal member 5M. The fixed metal member 5F is fixed to the fixed base 18D of the base member 18. The movable metal member 5M is fixed to the movable base 2D of the lens holder 2. The fixed metal member 5F may be embedded in the fixed base 18D of the base member 18, and the movable metal member 5M may be embedded in the movable base 2D of the lens holder 2.

More specifically, the fixed metal member 5F is also referred to as a fixed terminal plate, and includes a first fixed terminal plate 5F1 to an eighth fixed terminal plate 5F8. The movable metal member 5M is also referred to as a movable terminal plate, and includes a first movable terminal plate 5M1 to a fourth movable terminal plate 5M4.

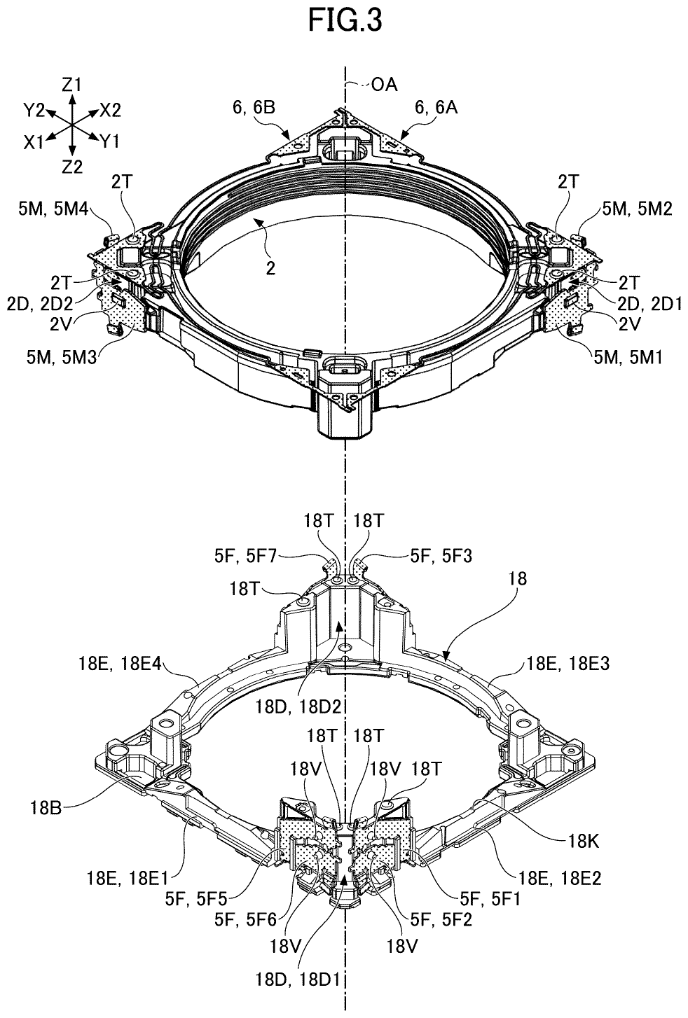

Next, a positional relationship between: each of the lens holder 2 and the base member 18; and the metal member 5 will be described with reference to FIG. 3. The upper view of FIG. 3 is a perspective view of the lens holder 2 to which the movable metal member 5M (movable terminal plate) and the leaf spring 6 are attached. The lower view of FIG. 3 is a perspective view of the base member 18 to which the fixed metal member 5F (fixed terminal plate) is attached. For clarification, the movable metal member 5M and the leaf spring 6 in the upper view of FIG. 3 are shown with a dot pattern, and the fixed metal member 5F in the lower view of FIG. 3 is shown with a dot pattern.

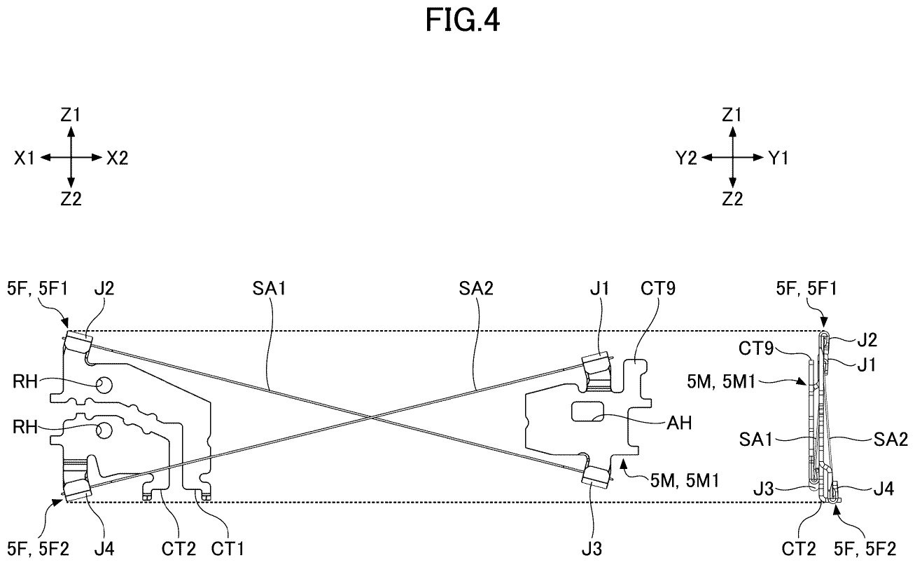

In the example as illustrated in the upper view of FIG. 3, the first movable terminal plate 5M1 is fixed to the outer surface of a side wall of the first movable base 201 on the Y1 side (right attachment surface). Specifically, the first movable terminal plate 5M1 is fixed with an adhesive to the first movable base 201 in a state in which a rectangular projection 2V that projects outward (Y1-side) and is formed at the first movable base 2D1 is engaged with a rectangular hole AH (see the left-hand view of FIG. 4) formed in the first movable terminal plate 5M1. The adhesive is a photocurable adhesive or the like. The photocurable adhesive is a UV-curable adhesive, a visible light-curable adhesive, or the like. Similarly, the second movable terminal plate 5M2 is fixed to the outer surface of a side wall of the first movable base 2D1 on the X2 side (rear attachment surface), a third movable terminal plate 5M3 is fixed to the outer surface of a side wall of the second movable base 2D2 on the X1 side (front attachment surface), and a fourth movable terminal plate 5M4 is fixed to the outer surface of a side wall of the second movable base 2D2 on the Y2 side (left attachment surface). In the example as illustrated in the lower view of FIG. 3, the first fixed terminal plate 5F1 and the second fixed terminal plate 5F2 are fixed to the outer surface of a side wall of the first fixed base 18D1 on the Y1 side (right attachment surface) disposed along a second side portion 18E2 of the base member 18. Specifically, the first fixed terminal plate 5F1 and the second fixed terminal plate 5F2 are fixed to the first fixed base 18D1 with an adhesive in a state in which two circular projections 18V that project outward (Y1-side) and are formed in the first fixed base 18D1 are fitted into through-holes RH (see the left-hand view of FIG. 4) formed in the first fixed terminal plate 5F1 and the second fixed terminal plate 5F2. The adhesive is a photocurable adhesive or the like. The photocurable adhesive is a UV-curable adhesive, a visible light-curable adhesive, or the like. Similarly, a third fixed terminal plate 5F3 and a fourth fixed terminal plate 5F4 (invisible in the lower view of FIG. 3) are fixed to the outer surface of a side wall of the second fixed base 18D2 on the X2 side (rear attachment surface) disposed along a third side portion 18E3 of the base member 18. A fifth fixed terminal plate 5F5 and a sixth fixed terminal plate 5F6 are fixed to the outer surface of a side wall of the first fixed base 18D1 on the X1 side (front attachment surface) disposed along the first side portion 18E1 of the base member 18. A seventh fixed terminal plate 5F7 and an eighth fixed terminal plate 5F8 (invisible in the lower view of FIG. 3) are fixed to the outer surface of a side wall of the second fixed base 18D2 on the Y2 side (left attachment surface) disposed along the fourth side portion 18E4 of the base member 18.

As illustrated in FIG. 2, the shape memory alloy wire SA extends along the inner surface of the first outer peripheral wall 4A of the upper cover member 4U, and is configured to support the movable member MB so as to be movable relative to the fixed member FB. In the present embodiment, the shape memory alloy wire SA includes the first wire SA1 to the eighth wire SA8, and is configured to support the lens holder 2 serving as the movable member MB so as to be movable relative to the base member 18 serving as the fixed member FB. As illustrated in FIG. 2, one end of each of the first wire SA1 to the eighth wire SA8 is fixed to the movable metal member 5M through crimping, welding, or the like, and the other end thereof is fixed to the fixed metal member 5F through crimping, welding, or the like.

Next, the metal member 5 to which the shape memory alloy wire SA is attached will be described with reference to FIG. 4. The left-hand view of FIG. 4 is a view, as seen from the Y1 side, of: the first wire SA1 attached to the first movable terminal plate 5M1 and the first fixed terminal plate 5F1; and the second wire SA2 attached to the first movable terminal plate 5M1 and the second fixed terminal plate 5F2. The right-hand view of FIG. 4 is a view, as seen from the X1 side, of: the first wire SAL attached to the first movable terminal plate 5M1 and the first fixed terminal plate 5F1; and the second wire SA2 attached to the first movable terminal plate 5M1 and the second fixed terminal plate 5F2. The positional relationship between the members as illustrated in the left- and right-hand views of FIG. 4 corresponds to a positional relationship between the members of the lens driving device 101 that is assembled. In the left- and right-hand views of FIG. 4, for clarification, illustration of the other members is omitted. The following description to be made with reference to the left- and right-hand views of FIG. 4 relates to a combination of the first wire SA1 and the second wire SA2. However, the same is applicable to a combination of the third wire SA3 and the fourth wire SA4, a combination of the fifth wire SA5 and the sixth wire SA6, and a combination of the seventh wire SA7 and the eighth wire SA8.

Specifically, one end of the first wire SA1 is fixed to the first movable terminal plate 5M1 at a lower holding portion J3 of the first movable terminal plate 5M1, and the other end of the first wire SAL is fixed to the first fixed terminal plate 5F1 at a holding portion J2 of the first fixed terminal plate 5F1. Similarly, one end of the second wire SA2 is fixed to the first movable terminal plate 5M1 at an upper holding portion J1 of the first movable terminal plate 5M1, and the other end of the second wire SA2 is fixed to the second fixed terminal plate 5F2 at a holding portion J4 of the second fixed terminal plate 5F2.

The holding portion J1 is formed by bending a part of the first movable terminal plate 5M1. Specifically, the part of the first movable terminal plate 5M1 is bent in a state of holding one end of the second wire SA2, thereby forming the holding portion J1. That end of the second wire SA2 is fixed to the holding portion J1 through welding. The same applies to the holding portions J2 to J4.

As illustrated in the left-hand view of FIG. 4, the first wire SAL and the second wire SA2 are disposed so as to be at a skewed position from each other. That is, the first wire SA1 and the second wire SA2 are disposed so as not to contact each other (i.e., so as to be in non-contact).

Next, the base member 18 that is a part of the fixed member FB will be described in detail with reference to FIG. 5. FIG. 5 is a perspective view of the base member 18. Specifically, the upper view of FIG. 5 is a perspective view of the base member 18 with a conductive member CM removed, the central view of FIG. 5 is a perspective view of the conductive member CM embedded in the base member 18, and the lower view of FIG. 5 is a perspective view of the base member 18 with the conductive member CM embedded. In the lower view of FIG. 5, for clarification, the conductive member CM is shown with a dot pattern.

The base member 18 functions as a wire support configured to support the other end of each of the first wire SA1 to the eighth wire SA8. With this configuration, the movable member MB is supported by the first wire SA1 to the eighth wire SA8 in a state of being movable in a Z-axis direction, i.e., a direction parallel to the optical axis OA.

The fixed base 18D is formed on an upper surface of the base member 18, i.e., a surface of the base member 18 on the subject side (Z1-side surface). The fixed base 18D includes the first fixed base 18D1 and the second fixed base 18D2. The first fixed base 18D1 and the second fixed base 18D2 are disposed to face each other across the optical axis OA.

The conductive member CM as illustrated in the central view of FIG. 5 is embedded in the base member 18 through insert molding. In the present embodiment, the conductive member CM is formed of a magnetic metal, such as iron or the like. The conductive member CM includes a first terminal portion TM1 to an eleventh terminal portion TM11, and a ninth joint surface portion CP9 and a tenth joint surface portion CP10. The first terminal portion TM1 to the eleventh terminal portion TM11 project from the lower surface (Z2-side surface) of the base member 18 and extend downward (Z2-direction). The ninth joint surface portion CP9 and the tenth joint surface portion CP10 are exposed to the upper surface (Z1-side surface) of the base member 18.

Specifically, the conductive member CM includes a first conductive member CM1 to an eleventh conductive member CM11. The first conductive member CM1 includes the first terminal portion TM1 and a first connection portion ED1. The second conductive member CM2 includes the second terminal portion TM2 and a second connection portion ED2. The third conductive member CM3 includes the third terminal portion TM3 and a third connection portion ED3. The fourth conductive member CM4 includes the fourth terminal portion TM4 and a fourth connection portion ED4. The fifth conductive member CM5 includes the fifth terminal portion TM5 and a fifth connection portion ED5. The sixth conductive member CM6 includes the sixth terminal portion TM6 and a sixth connection portion ED6. The seventh conductive member CM7 includes the seventh terminal portion TM7 and a seventh connection portion ED7. The eighth conductive member CM8 includes the eighth terminal portion TM8 and an eighth connection portion ED8. The ninth conductive member CM9 includes the ninth terminal portion TM9 and the ninth joint surface portion CP9. The tenth conductive member CM10 includes the tenth terminal portion TM10 and the tenth joint surface portion CP10. The eleventh conductive member CM11 includes the eleventh terminal portion TM11 and an eleventh connection portion ED11.

The first terminal portion TM1 to the fourth terminal portion TM4, the tenth terminal portion TM10, and the eleventh terminal portion TM11 are disposed along the third side portion 18E3 of the base member 18. The fifth terminal portion TM5 to the ninth terminal portion TM9 are disposed along the first side portion 18E1 of the base member 18.

That is, the first connection portion ED1 of the first conductive member CM1 is disposed along the second side portion 18E2 of the base member 18, and the first terminal portion TM1 of the first conductive member CM1 is disposed along the third side portion 18E3 of the base member 18 rather than the second side portion 18E2 of the base member 18. Similarly, the second connection portion ED2 of the second conductive member CM2 is disposed along the second side portion 18E2 of the base member 18, and the second terminal portion TM2 of the second conductive member CM2 is disposed along the third side portion 18E3 of the base member 18 rather than the second side portion 18E2 of the base member 18.

The seventh connection portion ED7 of the seventh conductive member CM7 is disposed along the fourth side portion 18E4 of the base member 18, and the seventh terminal portion TM7 of the seventh conductive member CM7 is disposed along the first side portion 18E1 of the base member 18 rather than the fourth side portion 18E4 of the base member 18. Similarly, the eighth connection portion ED8 of the eighth conductive member CM8 is disposed along the fourth side portion 18E4 of the base member 18, and the eighth terminal portion TM8 of the eighth conductive member CM8 is disposed along the first side portion 18E1 of the base member 18 rather than the fourth side portion 18E4 of the base member 18.

In this manner, the first terminal portion TM1 to the eleventh terminal portion TM11 are disposed along the first side portion 18E1 or the third side portion 18E3 of the base member 18, and are not disposed along the second side portion 18E2 and the fourth side portion 18E4 of the base member 18.

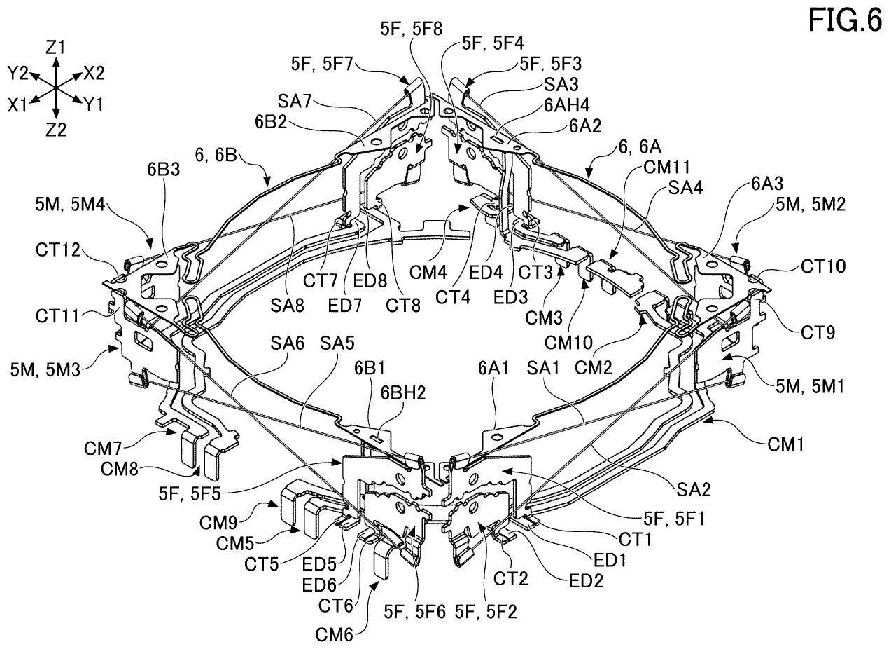

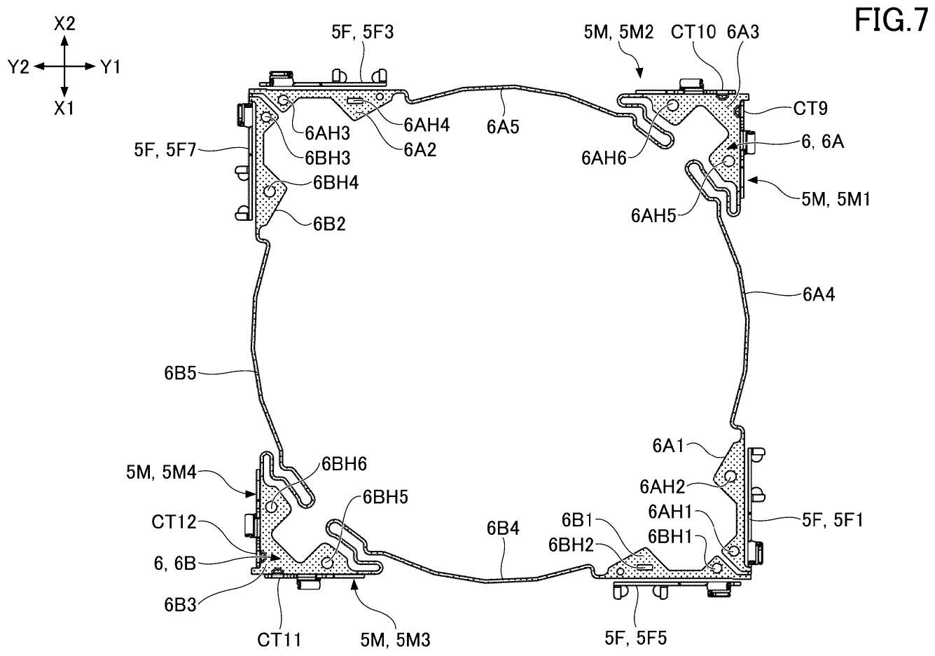

Next, the positional relationship between the leaf spring 6, the shape memory alloy wire SA, the metal member 5, and the conductive member CM will be described with reference to FIGS. 6 and 7. FIGS. 6 and 7 are views illustrating the positional relationship between the leaf spring 6, the shape memory alloy wire SA, the metal member 5, and the conductive member CM. Specifically, FIG. 6 is a perspective view of the members, i.e., the leaf spring 6, the shape memory alloy wire SA, the metal member 5, and the conductive member CM. FIG. 7 is a top view of these members. In FIG. 7, for clarification, illustration of the shape memory alloy wire SA and the conductive member CM is omitted. In FIG. 7, for clarification, the leaf spring 6 is shown with a dot pattern.

As illustrated in FIG. 7, the leaf spring 6 includes the first leaf spring 6A and the second leaf spring 6B. The first leaf spring 6A includes: a first portion 6A1 to be fixed to the first fixed base 18D1 (see FIG. 2) of the base member 18; a second portion 6A2 to be fixed to the second fixed base 18D2 (see FIG. 2) of the base member 18; a third portion 6A3 to be fixed to the first movable base 2D1 (see FIG. 2) of the lens holder 2; a fourth portion 6A4 connecting the first portion 6A1 and the third portion 6A3; and a fifth portion 6A5 connecting the second portion 6A2 and the third portion 6A3.

The first portion 6A1 is provided with a first through-hole 6AH1 and a second through-hole 6AH2 through which round projections 18T projecting upward (see the lower view of FIG. 3) formed in the first fixed base 18D1 are to be inserted. In the present embodiment, bonding between the leaf spring 6 and the projections 18T is achieved by treating the projections 18T through heat caulking or cold caulking. However, the bonding between the leaf spring 6 and the projections 18T may be achieved with an adhesive.

The second portion 6A2 is provided with: a third through-hole 6AH3 through which the round projection 18T projecting upward (see the lower view of FIG. 3) formed in the second fixed base 18D2 is to be inserted; and a fourth through-hole 6AH4 used for bonding to the tenth joint surface portion CP10 (see the lower view of FIG. 5) of the tenth conductive member CM10. In the present embodiment, bonding between the leaf spring 6 and the conductive member CM is achieved through welding, such as laser welding or the like. However, the bonding between the leaf spring 6 and the conductive member CM may be achieved with a solder, a conductive adhesive, or the like.

The third portion 6A3 is provided with a fifth through-hole 6AH5 and a sixth through-hole 6AH6 through which the round projections 2T projecting upward (see the upper view of FIG. 3) formed in the first movable base 201 are to be inserted. In the present embodiment, the bonding between the leaf spring 6 and the projections 2T is achieved by treating the projections 2T through heat caulking or cold caulking. However, the bonding between the leaf spring 6 and the projections 2T may be achieved with an adhesive.

Similarly, the second leaf spring 6B includes a first portion 6B1 to be fixed to the first fixed base 18D1 (see FIG. 2) of the base member 18; a second portion 6B2 to be fixed to the second fixed base 18D2 (see FIG. 2) of the base member 18; a third portion 6B3 to be fixed to the second movable base 2D2 (see FIG. 2) of the lens holder 2; a fourth portion 6B4 connecting the first portion 6B1 and the third portion 6B3; and a fifth portion 6B5 connecting the second portion 6B2 and the third portion 6B3.

The first portion 6B1 is provided with: a first through-hole 6BH1 through which the round projection 18T projecting upward (see the lower view of FIG. 3) formed in the first fixed base 18D1 is to be inserted; and a second through-hole 6BH2 used for bonding to the ninth joint surface portion CP9 (see the lower view of FIG. 5) of the ninth conductive member CM9.

The second portion 6B2 is provided with a third through-hole 6BH3 and a fourth through-hole 6BH4 through which the round projections 18T projecting upward (see the lower view of FIG. 3) formed in the second fixed base 18D2 are to be inserted.

The third portion 6B3 is provided with a fifth through-hole 6BH5 and a sixth through-hole 6BH6 through which the round projections 2T projecting upward (see the upper view of FIG. 3) formed in the second movable base 2D2 are to be inserted.

The fourth portion 6A4 and the fifth portion 6A5 of the first leaf spring 6A, and the fourth portion 6B4 and the fifth portion 6B5 of the second leaf spring 6B are elastically deformable arms including multiple bent portions. Therefore, the lens holder 2 is movable relative to the base member 18 (fixed member FB) not only in the direction parallel to the optical axis OA but also in the direction crossing the optical axis OA.

As illustrated in FIG. 7, the first leaf spring 6A and the second leaf spring 6B have approximately the same shape. Specifically, the first leaf spring 6A and the second leaf spring 6B are configured so as to be in a two-fold rotational symmetry with respect to the optical axis OA. Therefore, this configuration can reduce the number of parts of the lens driving device 101. Also, the first leaf spring 6A and the second leaf spring 6B can support the lens holder 2 in air in a well-balanced manner. Also, the leaf spring 6 does not adversely influence the weight balance of the movable member MB supported by the eight shape memory alloy wires SA (the first wire SA1 to the eighth wire SA8).

As illustrated in FIG. 6, the first connection portion ED1 of the first conductive member CM1 is bonded through soldering to a connection portion CT1 of the first fixed terminal plate 5F1. That is, the first connection portion ED1 and the connection portion CT1 are bonded in a state in which surfaces thereof are approximately parallel to each other. Similarly, the second connection portion ED2 of the second conductive member CM2 is bonded through soldering to a connection portion CT2 of the second fixed terminal plate 5F2. The third connection portion ED3 of the third conductive member CM3 is bonded through soldering to a connection portion CT3 of the third fixed terminal plate 5F3. The fourth connection portion ED4 of the fourth conductive member CM4 is bonded through soldering to a connection portion CT4 of the fourth fixed terminal plate 5F4. The fifth connection portion ED5 of the fifth conductive member CM5 is bonded through soldering to a connection portion CT5 of the fifth fixed terminal plate 5F5. The sixth connection portion ED6 of the sixth conductive member CM6 is bonded through soldering to a connection portion CT6 of the sixth fixed terminal plate 5F6. The seventh connection portion ED7 of the seventh conductive member CM7 is bonded through soldering to a connection portion CT7 of the seventh fixed terminal plate 5F7. The eighth connection portion ED8 of the eighth conductive member CM8 is bonded through soldering to a connection portion CT8 of the eighth fixed terminal plate 5F8.

As illustrated in FIG. 7, a connection portion CT9 of the first movable terminal plate 5M1 is vertically bonded through soldering to the third portion 6A3 of the first leaf spring 6A. That is, the connection portion CT9 and the third portion 6A3 are bonded in a state in which surfaces thereof are approximately perpendicular to each other. Similarly, a connection portion CT10 of the second movable terminal plate 5M2 is vertically bonded through soldering to the third portion 6A3 of the first leaf spring 6A. A connection portion CT11 of the third movable terminal plate 5M3 is vertically bonded through soldering to the third portion 6B3 of the second leaf spring 6B. A connection portion CT12 of the fourth movable terminal plate 5M4 is vertically bonded through soldering to the third portion 6B3 of the second leaf spring 6B.

Meanwhile, as illustrated in FIG. 7, the first fixed terminal plate 5F1 is disposed apart from the first portion 6A1 of the first leaf spring 6A, and does not contact the first portion 6A1 of the first leaf spring 6A. Similarly, the third fixed terminal plate 5F3 does not contact the second portion 6A2 of the first leaf spring 6A. The fifth fixed terminal plate 5F5 does not contact the first portion 6B1 of the second leaf spring 6B. The seventh fixed terminal plate 5F7 does not contact the second portion 6B2 of the second leaf spring 6B.

As illustrated in FIG. 6, the ninth joint surface CP9 (see the central view of FIG. 5) of the ninth conductive member CM9 is bonded through welding (e.g., laser welding or the like) to the first portion 6B1 of the second leaf spring 6B in parallel thereto at the second through-hole 6BH2 formed in the first portion 6B1 of the second leaf spring 6B. That is, the ninth joint surface portion CP9 and the first portion 6B1 are bonded in a state in which surfaces thereof are approximately parallel to each other. Similarly, as illustrated in FIG. 6, the tenth joint surface portion CP10 (see the central view of FIG. 5) of the tenth conductive member CM10 is bonded through welding (e.g., laser welding or the like) to the second portion 6A2 of the first leaf spring 6A in parallel thereto at the fourth through-hole 6AH4 formed in the second portion 6A2 of the first leaf spring 6A.

When the first terminal portion TM1 of the first conductive member CM1 is connected to a high potential and the tenth terminal portion TM10 of the tenth conductive member CM10 is connected to a low potential, the current flows from the first terminal portion TM1 to the first fixed terminal plate 5F1 through the first conductive member CM1. Subsequently, the current passes through the first fixed terminal plate 5F1, through the first wire SA1, and through the first movable terminal plate 5M1. Subsequently, the current passes through the third portion 6A3, the fifth portion 6A5, and the second portion 6A2 of the first leaf spring 6A, and flows through the tenth conductive member CM10 to the tenth terminal TM10.

When the second terminal portion TM2 of the second conductive member CM2 is connected to a high potential and the tenth terminal portion TM10 of the tenth conductive member CM10 is connected to a low potential, the current flows from the second terminal portion TM2 to the second fixed terminal plate 5F2 through the second conductive member CM2. Subsequently, the current passes through the second fixed terminal plate 5F2, through the second wire SA2, and through the first movable terminal plate 5M1. Subsequently, the current passes through the third portion 6A3, the fifth portion 6A5, and the second portion 6A2 of the first leaf spring 6A, and through the tenth conductive member CM10 to the tenth terminal portion TM10.

In both of the case in which the first terminal portion TM1 of the first conductive member CM1 is connected to a high potential and the case in which the second terminal portion TM2 of the second conductive member CM2 is connected to a high potential, the path of the current flowing from the first movable terminal plate 5M1 to the tenth terminal portion TM10 is the same.

By controlling the voltage applied to the terminals of the first conductive member CM1 to the tenth conductive member CM10, a controller located externally of the lens driving device 101 as described above can control the shrinkage of the first wire SA1 to the eighth wire SA8. The controller may be disposed in the lens driving device 101. The controller may be a component of the lens driving device 101.

The lens driving device 101 having an approximately rectangular parallelepiped shape is attached, for example, onto an unillustrated external substrate on which an unillustrated imaging element is mounted. A camera module includes, for example, the external substrate, the lens driving device 101, the lens body mounted on the lens holder 2, and the imaging element mounted on the external substrate so as to face the lens body. The camera module may include a controller formed of a microcomputer including a CPU, a memory, and the like.

For example, the controller may move the lens holder 2 along the direction parallel to the optical axis OA on the Z1 side (subject side) of the imaging element by using the driving force caused in the direction parallel to the optical axis OA by the action of the shrinkage of the shape memory alloy wire SA serving as the driving mechanism MK. By moving the lens holder 2 in this manner, the controller may realize an automatic focus adjustment function, which is one of the lens adjustment functions. Specifically, the controller can achieve macro photography by moving the lens holder 2 in a direction away from the imaging element, and can achieve infinity photography by moving the lens holder 2 in a direction approaching the imaging element.

The controller may also move the lens holder 2 in the direction crossing the optical axis OA by controlling the current flowing through the shape memory alloy wires SA. Thereby, the controller can achieve an image stabilizing function.

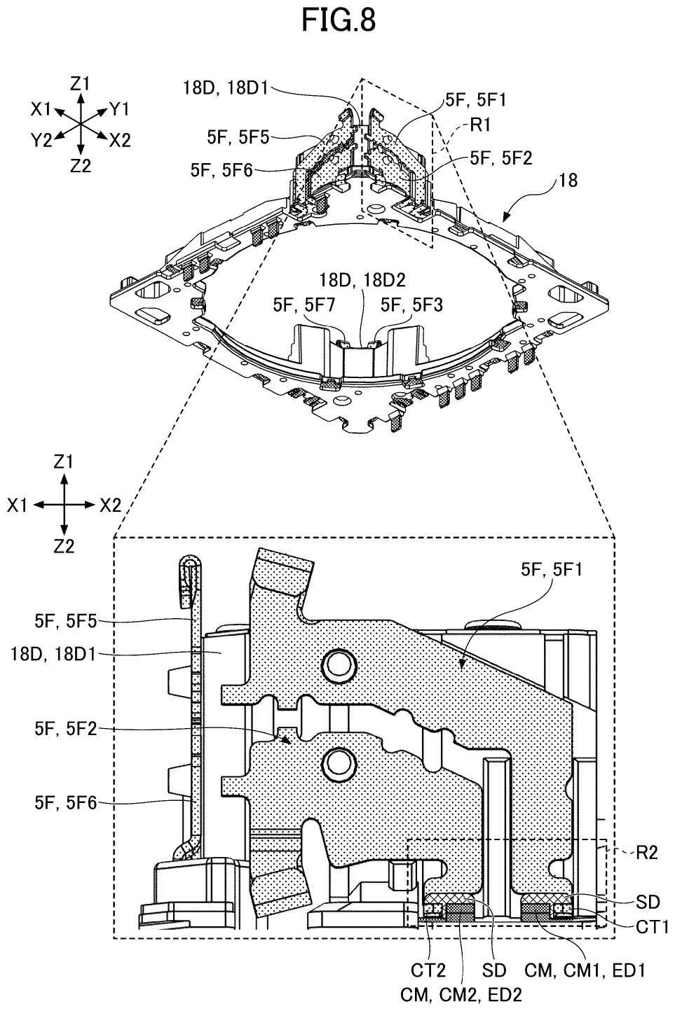

Next, an example of a connection structure that connects the fixed metal member 5F (fixed terminal plate) and the conductive member CM will be described with reference to FIG. 8. FIG. 8 is a view illustrating an example of the connection structure configured to connect the fixed metal member 5F (fixed terminal plate) and the conductive member CM. Specifically, the upper view of FIG. 8 is a perspective view of the entirety of the base member 18 to which the fixed metal member 5F (fixed terminal plate) is attached. The lower view of FIG. 8 is an enlarged side view of an area R1 enclosed by the broken line illustrated in the upper view of FIG. 8 as seen from the Y1 side. In FIG. 8, for clarification, the fixed metal member 5F (fixed terminal plate) is shown with a rough dot pattern, and the conductive member CM is shown with a fine dot pattern.

As illustrated in the lower view of FIG. 8, the first fixed terminal plate 5F1 is attached with a photocurable adhesive to the outer surface of the side wall of the first fixed base 18D1 of the base member 18 on the Y1 side (right attachment surface). The connection portion CT1 of the first fixed terminal plate 5F1 is bonded with a bonding material SD to the first connection portion ED1 of the first conductive member CM1. The bonding material SD is a solder, a conductive adhesive, or the like. In the lower view of FIG. 8, for clarification, the bonding material SD is shown with a cross pattern.

Similarly, the second fixed terminal plate 5F2 is attached with a photocurable adhesive to the outer surface of the side wall on the Y1 side of the first fixed base 18D1 of the base member 18 (right attachment surface). The connection portion CT2 of the second fixed terminal plate 5F2 is bonded to the second connection portion ED2 of the second conductive member CM2 via the bonding material SD.

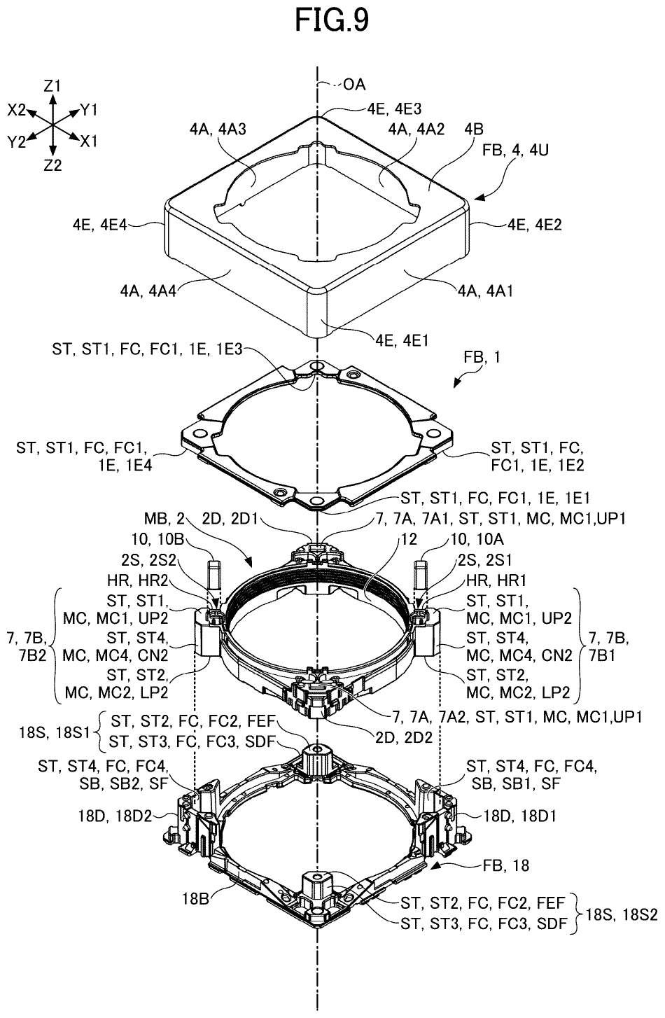

Next, a configuration for restricting the movement of the lens holder 2 with respect to the base member 18 when no current is flowing through the shape memory alloy wire SA will be described with respect to FIG. 9. FIG. 9 is a perspective view of the spacer 1, the lens holder 2, the upper cover member 4U, and the base member 18.

As illustrated in FIG. 9, the lens holder 2 includes: the cylindrical portion 12 extending in the optical axis direction and housing the lens body; and the movable base 2D and the projection 2S that are located at positions corresponding to corners 4E of the upper cover member 4U and project from the cylindrical portion 12 toward the corners 4E.

Specifically, the upper cover member 4U includes the four corners 4E. The four corners 4E include: a first corner 4E1 disposed between the first side plate 4A1 and the fourth side plate 4A4; a second corner 4E2 disposed between the first side plate 4A1 and the second side plate 4A2; a third corner 4E3 disposed between the second side plate 4A2 and the third side plate 4A3; and a fourth corner 4E4 disposed between the third side plate 4A3 and the fourth side plate 4A4.

The lens holder 2 includes: a second movable base 2D2 projecting from the cylindrical portion 12 toward the first corner 4E1; a first projection 21 projecting from the cylindrical portion 12 toward the second corner 4E2; a first movable base 201 projecting from the cylindrical portion 12 toward the third corner 4E3; and a second projection 2S2 projecting from the cylindrical portion 12 toward the fourth corner 4E4.

A housing portion HR opened upward (in the Z1 direction) is formed in the projection 2S. A first magnetic member 10 is housed in the housing portion HR and fixed with an adhesive. Specifically, a first housing portion HR1 opened upward is formed in the first projection 251, and a second housing portion HR2 opened upward is formed in the second projection 22. A first magnet 10A is housed in the first housing portion HR1, and a second magnet 10B is housed in the second housing portion HR2.

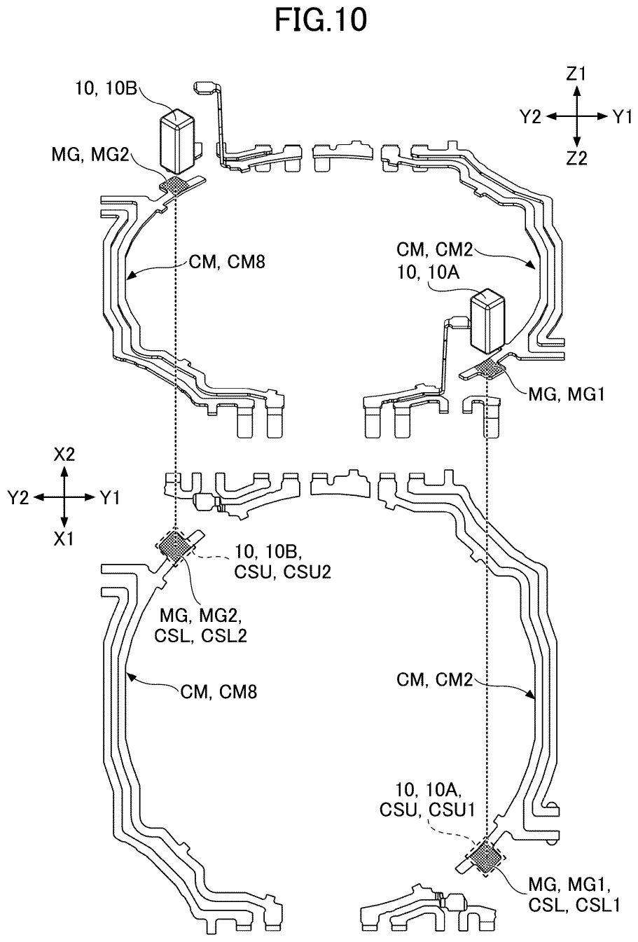

The first magnetic member 10 is a member configured to generate a magnetic attraction force between the first magnetic member 10 and a second magnetic member MG attached to the base member 18 (see FIG. 10). In the example illustrated in FIG. 9, the first magnetic member 10 includes the first magnet 10A and the second magnet 10B. Both of the first magnet 10A and the second magnet 10B are bipolar permanent magnets. However, the first magnetic member 10 may not be a magnet as long as the first magnetic member 10 can generate a magnetic attraction force between the first magnetic member 10 and the second magnetic member MG. In this case, the first magnetic member 10 may be formed of a magnetic metal, a magnetic resin material, or the like. The first magnetic member 10 may be embedded in the lens holder 2 through insert molding or the like, or may be attached to the lens holder 2.

Next, the positional relationship between the first magnetic member 10 and the second magnetic member MG when no current is flowing through the shape memory alloy wire SA will be described with reference to FIG. 10. FIG. 10 illustrates the positional relationship, when no current is flowing through the shape memory alloy wire SA, between: the first magnetic member 10 attached to the lens holder 2; and the second magnetic member MG included in the conductive member CM embedded in the base member 18. Specifically, the upper view of FIG. 10 is a perspective view of the first magnetic member 10 and the conductive member CM, and the lower view of FIG. 10 is a top view of the conductive member CM. In the upper view of FIG. 10 and the lower view of FIG. 10, for clarification, illustration of the members other than the first magnetic member 10 and the conductive member CM is omitted. In the upper view of FIG. 10 and the lower view of FIG. 10, for clarification, the second magnetic member MG that is a part of the conductive member CM embedded in the base member 18 is shown with a dot pattern. In the lower view of FIG. 10, for clarification, the outline of the first magnetic member 10 is shown with a dotted line.

The second magnetic member MG is a member configured to generate a magnetic attraction force between the second magnetic member MG and the first magnetic member 10 attached to the lens holder 2. In the example illustrated in FIG. 10, the second magnetic member MG includes a first metal plate MG1 and a second metal plate MG2. Both of the first metal plate MG1 and the second metal plate MG2 are formed of a magnetic metal. Specifically, the first metal plate MG1 is formed as a part of the second conductive member CM2, and the second metal plate MG2 is formed as a part of the eighth conductive member CM8. However, the second magnetic member MG may not be formed of a magnetic metal as long as the second magnetic member MG can generate a magnetic attraction force between the second magnetic member MG and the first magnetic member 10. In this case, the second magnetic member MG may be a magnet. Also, the second magnetic member MG may be formed as a member independent of the conductive member CM. In this case, the conductive member CM is desirably formed of a non-magnetic material, such as a non-magnetic metal or the like. Also, the second magnetic member MG does not need to be embedded in the base member 18, but may be attached to the base member 18.

When no current is flowing through the shape memory alloy wire SA, as illustrated in the upper view of FIG. 10 and the lower view of FIG. 10, the first magnetic member 10 is disposed in the housing portion HR formed in the projection 2S of the lens holder 2 so as to be positioned directly above the second magnetic member MG in a state of being away from the second magnetic member MG by a predetermined distance.

As illustrated in the lower view of FIG. 10, the first magnetic member 10 and the second magnetic member MG are configured such that the area of an upper facing surface CSU of the first magnetic member 10 facing the second magnetic member MG is substantially equal to the area of a lower facing surface CSL of the second magnetic member MG facing the first magnetic member 10. The reason for this is as follows. Specifically, when the area of the upper facing surface CSU and the area of the lower facing surface CSL are significantly different, the positional relationship between the first magnetic member 10 and the second magnetic member MG varies when the first magnetic member 10 is attracted, and then stopped, to the second magnetic member MG by the action of a magnetic attraction force generated between the first magnetic member 10 and the second magnetic member MG.

Specifically, as illustrated in the lower view of FIG. 10, the first magnet 10A and the first metal plate MG1 are configured such that the area of an upper facing surface CSU1 of the first magnet 10A facing the first metal plate MG1 is substantially equal to the area of a lower facing surface CSL1 of the first metal plate MG1 facing the first magnet 10A. Also, the second magnet 10B and the second metal plate MG2 are configured such that the area of an upper facing surface CSU2 of the second magnet 10B facing the second metal plate MG2 is substantially equal to the area of a lower facing surface CSL2 of the second metal plate MG2 facing the second magnet 10B.

In the example illustrated in FIG. 10, the first magnetic member 10 has an outer shape of an approximately rectangular parallelepiped, but may have another outer shape, such as a cylindrical shape, a hexagonal prism shape, or the like. That is, in the example illustrated in FIG. 10, the upper facing surface CSU has a rectangular outer shape, but may have another outer shape, such as a circular shape, a hexagonal shape, or the like. In this case, the lower facing surface CSL is desirably configured to have the same outer shape as the upper facing surface CSU.

As illustrated in FIG. 9, the base member 18 includes the fixed base 18D and a stopper projection 18S, projecting upward from the base portion 18B, at positions corresponding to the corners 4E of the upper cover member 4U. The stopper projection 18S includes a first stopper projection 18S1 and a second stopper projection 18S2. Specifically, the base member 18 includes: a second stopper projection 1852 provided near the first corner 4E1; a first fixed base 18D1 provided near the second corner 4E2; a first stopper projection 18S1 provided near the third corner 4E3; and a second fixed base 18D2 provided near the fourth corner 4E4.

The fixed base 18D is provided with a stopper recess SB opened upward (Z1 direction) and inward (direction closer to the optical axis OA). Specifically, the first fixed base 18D1 is provided with a first stopper recess SB1 opened upward and inward, and the second fixed base 18D2 is provided with a second stopper recess SB2 opened upward and inward. The stopper recess SB houses a projection 2S that functions as a stopper projection.

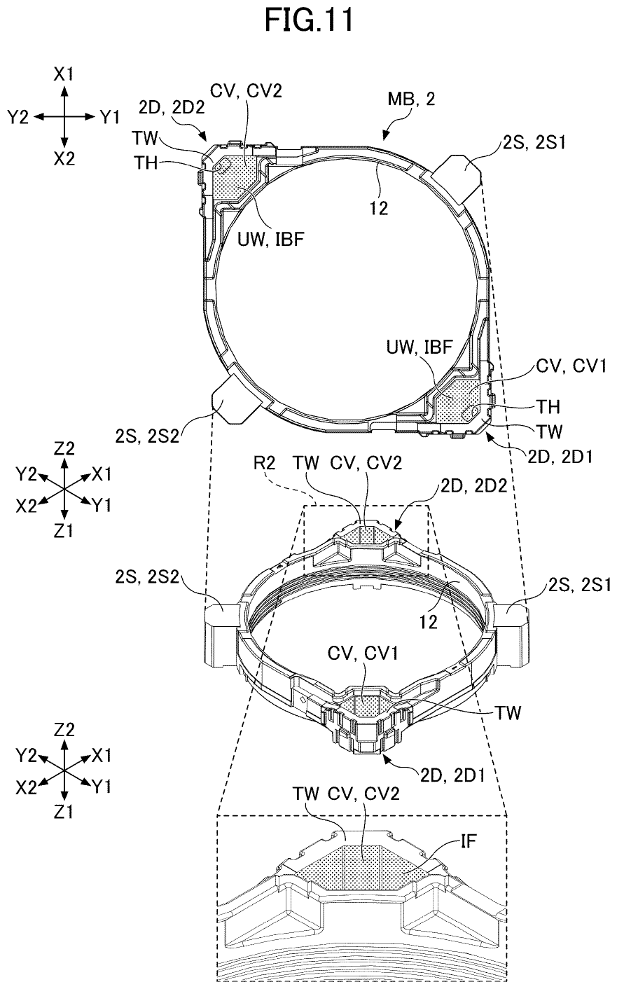

As illustrated in FIG. 11, a stopper recess CV is formed at the lower surface (Z2-side surface) of the movable base 2D of the lens holder 2. FIG. 11 is a detailed view of the lens holder 2. Specifically, the upper view of FIG. 11 is a bottom view of the lens holder 2. The central view of FIG. 11 is a perspective view of the bottom surface of the lens holder 2. The lower view of FIG. 11 is an enlarged view of an area R2 enclosed by the broken line illustrated in the central view of FIG. 11. In FIG. 11, for clarification, the stopper recess CV is shown with a dot pattern.

Specifically, the first movable base 2D1 and the second movable base 2D2 each include: a cylindrical wall TW that has an approximately hexagonal shape in a bottom view; and an upper wall UW provided to connect the upper portions of the cylindrical wall TW. The lower surface of the first movable base 201 is provided with a first stopper recess CV1 defined by the cylindrical wall TW and the upper wall UW. The lower surface of the second movable base 2D2 is provided with a second stopper recess CV2 defined by the cylindrical wall TW and the upper wall UW. Also, a penetrating portion TH is formed in the upper wall UW forming an inner bottom surface IBF that is the Z1-side surface of each of the first stopper recess CV1 and the second stopper recess CV2. In the illustrated example, the penetrating portion TH is a substantially rectangular through-hole extending in the Z-axis direction and having the entirely closed periphery. However, the penetrating portion TH may be a cut-out portion that is partially opened.

The stopper recess CV includes the first stopper recess CV1 and the second stopper recess CV2, as described above. The stopper recess CV is configured to receive, in a non-contact manner, the stopper projection 18S (see FIG. 9) formed in the base member 18. The stopper projection 18S includes the first stopper projection 18S1 and the second stopper projection 18S2, as described above.

The stopper recess CV is configured to restrict excessive movement of the lens holder 2 in cooperation with the stopper projection 18S. Specifically, the stopper recess CV is configured to restrict excessive movement of the lens holder 2 by contacting the stopper projection 18S when the lens holder 2 moves excessively. The excessive movement of the lens holder 2 includes at least one selected from the group consisting of excessive rotation of the lens holder 2 about the optical axis OA, excessive translation of the lens holder 2 in the X-axis direction, excessive translation of the lens holder 2 in the Y-axis direction, and the like.

More specifically, the first stopper recess CV1 is configured to receive, in a non-contact manner, the first stopper projection 18S1 in a neutral state, and the second stopper recess CV2 is configured to receive, in a non-contact manner, the second stopper projection 1882 in a neutral state. The neutral state of the lens driving device 101 means, for example, a state in which the lens holder 2 is positioned in the middle of movable ranges in the three orthogonal axis directions (X-axis direction, Y-axis direction, and Z-axis direction). Typically, in the neutral state of the lens driving device 101, the lens holder 2 is positioned in the middle of the movable ranges of the three axis directions. However, the neutral state may be the initial state of the lens driving device 101 in a state in which no power is supplied to the shape memory alloy wire SA.

Further, the stopper recess SB (see FIG. 9) of the base member 18 is configured to receive, in a non-contact manner, the projection 2S (stopper projection) of the lens holder 2 in the neutral state. The stopper recess SB is configured to restrict excessive movement of the lens holder 2 in cooperation with the stopper projection (projection 2S). Specifically, the stopper recess SB is configured to contact the stopper projection (projection 2S) and restrict excessive movement of the lens holder 2 when the lens holder 2 moves excessively.

More specifically, the stopper recess SB (see FIG. 9) includes: the first stopper recess SB1 formed on the inner side of the first fixed base 18D1; and the second stopper recess SB2 formed on the inner side of the second fixed base 18D2. The first stopper recess SB1 is configured to receive, in a non-contact manner, the first stopper projection (first projection 2S1) in the neutral state, and the second stopper recess SB2 is configured to receive, in a non-contact manner, the second stopper projection (second projection 2S2) in the neutral state.

In this manner, the stopper recess CV (movable base 2D) and the stopper projection (projection 2S) in the lens holder 2, and the stopper recess SB (fixed base 18D) and the stopper projection 18S in the base member 18 form a stopper ST configured to restrict excessive movement of the lens holder 2.

Specifically, the stopper ST is configured to restrict movement of the lens holder 2 with respect to the fixed member FB by contacting a part of the fixed member FB with a part of the lens holder 2. An elastic portion 7 is provided at a portion of the lens holder 2, the portion contacting the part of the fixed member FB.

The elastic portion 7 is formed of a material softer than a synthetic resin material forming the cylindrical portion 12 of the lens holder 2. For example, the elastic portion 7 is formed of, for example, a polyimide resin, silicone rubber, an elastomer, or the like that is softer than a synthetic resin material forming the cylindrical portion 12, such as a liquid crystal polymer (LCP) or the like. In the present embodiment, the elastic portion 7 is formed of silicone rubber, which can be readily molded (through double molding).

In the illustrated example, the elastic portion 7 is integrated with the lens holder 2 through double molding. Specifically, the elastic portion 7 includes: a first elastic portion 7A integrated with the movable base 2D of the lens holder 2; and a second elastic portion 7B integrated with the projection 2S of the lens holder 2. Double molding is also referred to as two color molding or double shot molding.

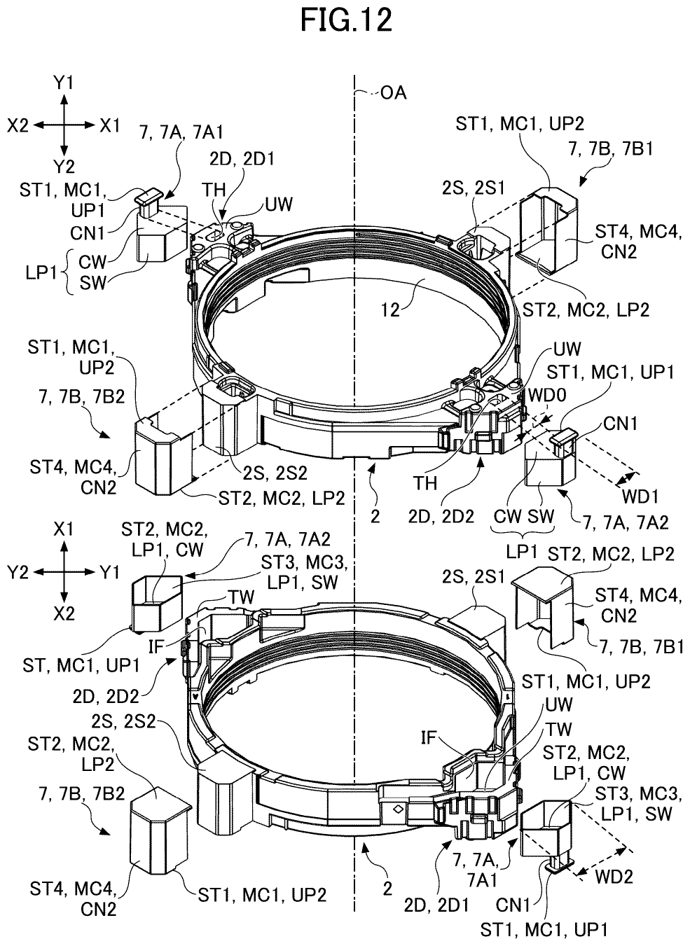

FIG. 12 is a perspective view of the elastic portion 7 and the lens holder 2. Specifically, the upper view of FIG. 12 is an upper perspective view of the elastic portion 7 and the lens holder 2, and the lower view of FIG. 12 is a lower perspective view of the elastic portion 7 and the lens holder 2. FIG. 12 illustrates a state in which the lens holder 2 and the elastic portion 7 are separated for describing them. However, in practice, the lens holder 2 and the elastic portion 7 are inseparably integrated (see FIG. 9). That is, the elastic portion 7 forms a part of the lens holder 2.

More specifically, the first elastic portion 7A includes: a first right-rear elastic portion 7A1 provided at the first movable base 2D1; and a first left-front elastic portion 7A2 provided at the second movable base 2D2. The first right-rear elastic portion 7A1 and the first left-front elastic portion 7A2 are formed to have the same shape and the same size. The first right-rear elastic portion 7A1 and the first left-front elastic portion 7A2 each include: an upper portion UP1 disposed in partial contact with the upper surface of the upper wall UW of the movable base 2D; a lower portion LP1 disposed in contact with the upper surface (inner bottom surface IBF) and an inner peripheral surface IF of the stopper recess CV (see FIG. 11); and a first connection portion CN1 disposed in the penetrating portion TH and connecting the upper portion UP1 and the lower portion LP1. The lower portion LP1 includes a ceiling surface CW provided at the lower surface of the upper wall UW of the lens holder 2 (inner bottom surface IBF that is the ceiling surface of the stopper recess CV); and an inner peripheral surface portion SW provided at the inner peripheral surface IF of the cylindrical wall TW (see the lower view of FIG. 11).

The second elastic portion 7B includes: a second right-front elastic portion 7B1 provided at the first projection 21; and a second left-rear elastic portion 7B2 provided at the second projection 2S2. The second right-front elastic portion 7B1 and the second left-rear elastic portion 7B2 each include: an upper portion UP2 disposed in contact with the upper surface of the upper projection 2S; a lower portion LP2 disposed in contact with the lower surface of the projection 2S; and a second connection portion CN2 disposed in contact with the side surface of the projection 2S and connecting the upper portion UP2 and the lower portion LP2.

As illustrated in FIG. 9, the stopper ST configured to restrict the movement of the lens holder 2 is formed of a combination of a movable contact MC and a fixed contact FC that contact each other. Specifically, the stopper ST includes a first stopper ST1 configured to restrict the movement of the lens holder 2 toward the Z1 side (upper side); a second stopper ST2 configured to restrict the movement of the lens holder 2 toward the Z2 side (lower side); and a third stopper ST3 and a fourth stopper ST4 configured to restrict the movement of the lens holder 2 in the direction crossing the optical axis direction.

The first stopper ST1 is formed of a combination of a first movable contact MC1 and a first fixed contact FC1. The second stopper ST2 is formed of a combination of a second movable contact MC2 and a second fixed contact FC2. The third stopper ST3 is formed of a combination of a third movable contact MC3 and a third fixed contact FC3. The fourth stopper ST4 is formed of a combination of a fourth movable contact MC4 and a fourth fixed contact FC4. That is, the movable contact MC includes the first movable contact MC1 to the fourth movable contact MC4, and the fixed contact FC includes the first fixed contact FC1 to the fourth fixed contact FC4.

As illustrated in FIG. 9, the first movable contact MC1 includes the upper portion UP1 of the first right-rear elastic portion 7A1, the upper portion UP1 of the first left-front elastic portion 7A2, the upper portion UP2 of the second right-front elastic portion 7B1, and the upper portion UP2 of the second left-rear elastic portion 7B2. Also, as illustrated in FIG. 9, the first fixed contact FC1 includes four corners 1E (first corner 1E1 to fourth corner 1E4) of the spacer 1.

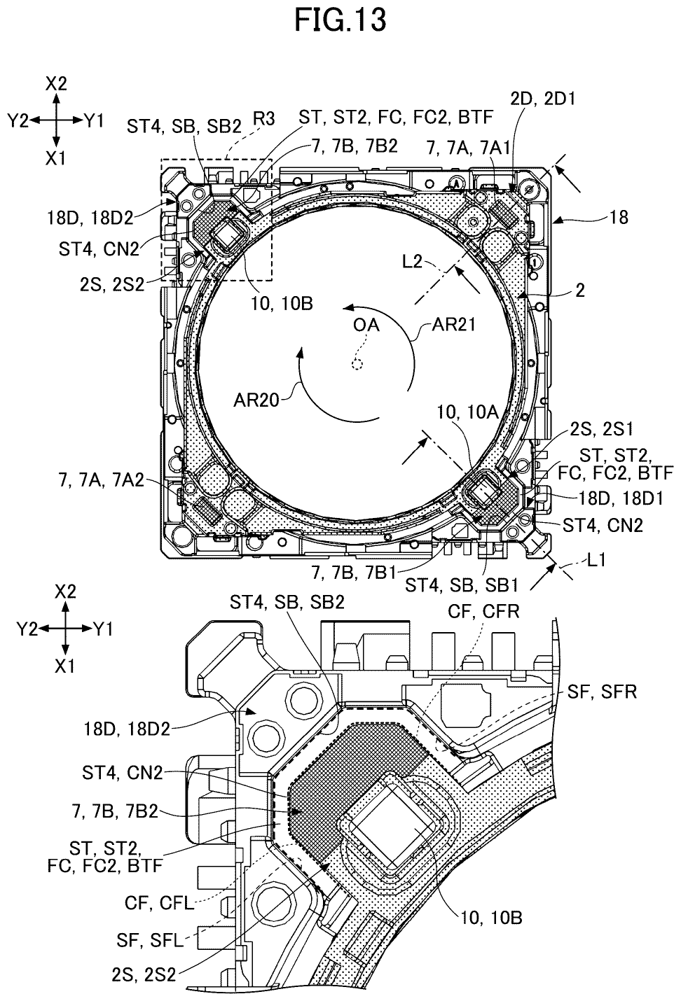

The second movable contact MC2 includes: the ceiling surface CW of the lower portion LP1 of the first right-rear elastic portion 7A1 (see the lower view of FIG. 12); the ceiling surface CW of the lower portion LP1 of the first left-front elastic portion 7A2 (see the lower view of FIG. 12); the lower portion LP2 of the second right-front elastic portion 7B1 (see FIG. 9); and the lower portion LP2 of the second left-rear elastic portion 7B2 (see FIG. 9). Also, the second fixed contact FC2 includes: a front end surface FEF of the first stopper projection 18S1 of the base member 18 (see FIG. 9); a front end surface FEF of the second stopper projection 18S2 of the base member 18 (see FIG. 9); a bottom surface BTF of the first stopper recess SB1 in the first fixed base 18D1 of the base member 18 (see the upper view of FIG. 13); and a bottom surface BTF of the second stopper recess SB2 in the second fixed base 18D2 of the base member 18 (see the upper view of FIG. 13).

The third movable contact MC3 includes: the inner peripheral surface portion SW of the lower portion LP1 of the first right-rear elastic portion 7A1 (see the lower view of FIG. 12); and the inner peripheral surface portion SW of the lower portion LP1 of the first left-front elastic portion 7A2 (see the lower view of FIG. 12). Also, the third fixed contact FC3 includes: a side surface SDF of the first stopper projection 18S1 of the base member 18 (see FIG. 9); and a side surface SDF of the second stopper projection 18S2 of the base member 18 (see FIG. 9).

As illustrated in FIG. 9, the fourth movable contact MC4 includes: the second connection portion CN2 of the second right-front elastic portion 7B1; and the second connection portion CN2 of the second left-rear elastic portion 7B2. Also, as illustrated in FIG. 9, the fourth fixed contact FC4 includes: a first stopper recess SB1 in the first fixed base 18D1 of the base member 18; and a second stopper recess SB2 in the second fixed base 18D2 of the base member 18.

Next, details of the stopper ST configured to restrict the movement of the lens holder 2 will be described with reference to FIG. 13. FIG. 13 is a top view of the lens holder 2 to which the elastic portion 7 and the first magnetic member 10 are attached, and of the base member 18 in which the second magnetic member MG is embedded. Specifically, the upper view of FIG. 13 is a top view illustrating the entirety of the lens holder 2 and the base member 18, and the lower view of FIG. 13 is an enlarged view of an area R3 enclosed by the broken line illustrated in the upper view of FIG. 13. In FIG. 13, for clarification, the lens holder 2 is shown with a dot pattern, and the elastic portion 7 is shown with a cross pattern.

As described above, the fourth stopper ST4 is formed of a combination of the fourth movable contact MC4 and the fourth fixed contact FC4. Specifically, as illustrated in the lower view of FIG. 13, the fourth stopper ST4 includes a combination of: the second left-rear elastic portion 7B2 having an outer peripheral surface CF (surface shown with a dotted line); and the second fixed base 18D2 (second stopper recess SB2) that is a wall having an inner peripheral surface SF (surface shown with a broken line) facing the outer peripheral surface CF so as to cover the outer peripheral surface CF. The outer peripheral surface CF and the inner peripheral surface SF face each other with a gap therebetween, and are disposed so as to be the closest to each other at the portions thereof extending parallel to the X axis and at the portions thereof extending parallel to the Y axis.

Similarly, as illustrated in the upper view of FIG. 13, the fourth stopper ST4 includes a combination of: the second right-front elastic portion 7B1 having an outer peripheral surface; and the first fixed base 18D1 (first stopper recess SB1) that is a wall having an inner peripheral surface facing and covering the outer peripheral surface of the second right-front elastic portion 7B1.

With this configuration, when the lens holder 2 is to excessively rotate about the optical axis OA in the direction indicated by an arrow AR20 in the upper view of FIG. 13, a right-hand portion CFR of the outer peripheral surface CF of the second left-rear elastic portion 7B2 and a right-hand portion SFR of the inner peripheral surface SF of the second fixed base 18D2 (second stopper recess SB2) contact each other at the fourth stopper ST4 as illustrated in the lower view of FIG. 13. This contact prevents the excessive rotation of the lens holder 2 about the optical axis OA. The same applies to the contact between the outer peripheral surface of the second right-front elastic portion 7B1 and the inner peripheral surface of the first fixed base 18D1 (first stopper recess SB1). These contacts occur at approximately the same timing.

Also, when the lens holder 2 is to excessively rotate about the optical axis OA in the direction indicated by an arrow AR21 in the upper view of FIG. 13, a left-hand portion CFL of the outer peripheral surface CF of the second left-rear elastic portion 7B2 and a left-hand portion SFL of the inner peripheral surface SF of the second fixed base 18D2 (second stopper recess SB2) contact each other at the fourth stopper ST4 as illustrated in the lower view of FIG. 13. This contact prevents the excessive rotation of the lens holder 2 about the optical axis OA. The same applies to the contact between the outer peripheral surface of the second right-front elastic portion 7B1 and the inner peripheral surface of the first fixed base 18D1 (first stopper recess SB1). These contacts occur at approximately the same timing.

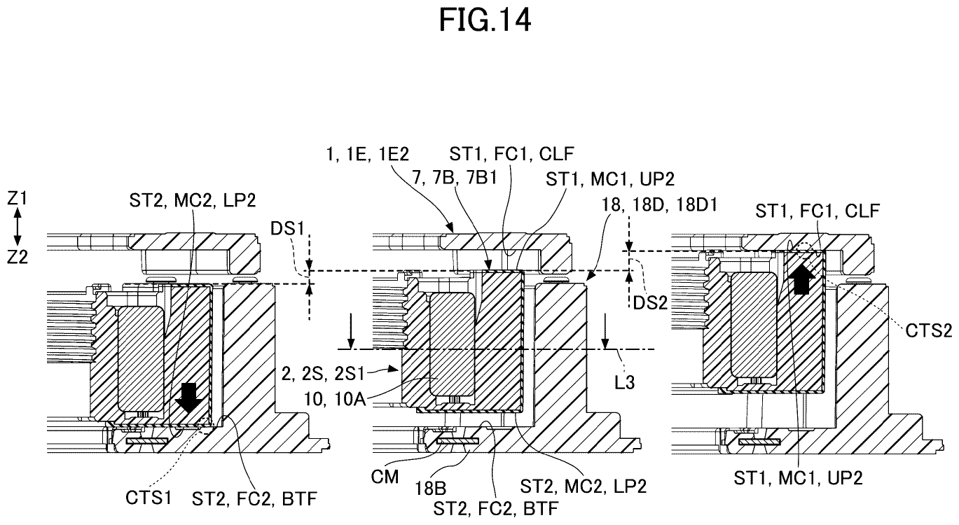

Next, an example of the state of the lens driving device 101 when the stopper ST functions will be described with reference to FIG. 14. FIG. 14 illustrates a cross-sectional surface of the lens holder 2, the elastic portion 7, the first magnetic member 10, the base member 18, and the conductive member CM in a plane perpendicular to an XY plane including a chain line L1 in the upper view of FIG. 13. Specifically, the central view of FIG. 14 illustrates the positional relationship of the members in the neutral state, the left-hand view of FIG. 14 illustrates the positional relationship of the members when the lens holder 2 moves downward (Z2 side), and the right-hand view of FIG. 14 illustrates the positional relationship of the members when the lens holder 2 moves upward (Z1 side). In FIG. 14, the direction of the movement of the lens holder 2 in the Z-axis direction is indicated by a black block arrow.

Specifically, as illustrated in the left-hand view of FIG. 14, when the lens holder 2 moves downward by a predetermined distance DS1 from the neutral state, the lower portion LP2 serving as the second movable contact MC2 forming the second stopper ST2 and the bottom surface BTF serving as the second fixed contact FC2 forming the second stopper ST2 contact each other at a contact surface CTS1 shown with a dotted circle, thereby restricting further downward movement of the lens holder 2. The lower portion LP2 is a part of the second right-front elastic portion 7B1, and the bottom surface BTF is a part of the first stopper recess SB1 in the first fixed base 18D1 of the base member 18.

Also, when the lens holder 2 moves upward from the neutral state by a predetermined distance DS2 as illustrated in the right-hand view of FIG. 14, the upper portion UP2 serving as the first movable contact MC1 forming the first stopper ST1 and a ceiling surface CLF serving as the first fixed contact FC1 forming the first stopper ST1 contact each other at a contact surface CTS2 shown with a dotted circle, thereby restricting further upward movement of the lens holder 2. The upper portion UP2 is a part of the second right-front elastic portion 7B1, and the ceiling surface CLF is a part of the second corner 1E2 of the spacer 1.

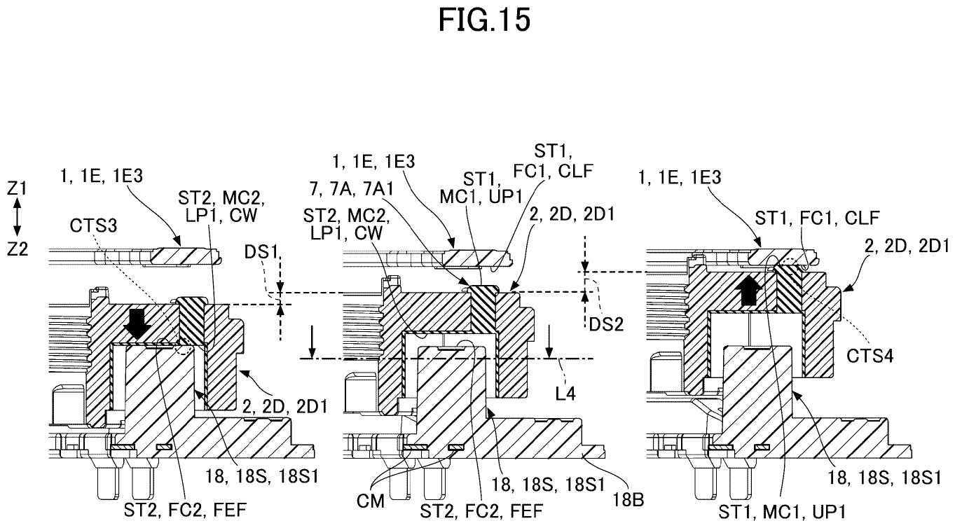

Next, another example of the state of the lens driving device 101 when the stopper ST functions will be described with reference to FIG. 15. FIG. 15 illustrates a cross-sectional view of the lens holder 2, the elastic portion 7, the base member 18, and the conductive member CM in a plane perpendicular to the XY plane including a chain line L2 in the upper view of FIG. 13. Specifically, the central view of FIG. 15 illustrates the positional relationship of the members in the neutral state, the left-hand view of FIG. 15 illustrates the positional relationship of the members when the lens holder 2 moves downward (Z2 side), and the right-hand view of FIG. 15 illustrates the positional relationship of the members when the lens holder 2 moves upward (Z1 side). In FIG. 15, the direction of the movement of the lens holder 2 in the Z-axis direction is indicated by a black block arrow.

Specifically, as illustrated in the left-hand view of FIG. 15, when the lens holder 2 moves downward by the predetermined distance DS1 from the neutral state, the ceiling surface CW serving as the second movable contact MC2 forming the second stopper ST2 and the front end surface FEF serving as the second fixed contact FC2 forming the second stopper ST2 contact each other at a contact surface CTS3 indicated by a dotted circle, thereby restricting further downward movement of the lens holder 2. The ceiling surface CW is a part of the lower portion LP1 of the first right-rear elastic portion 7A1, and the front end surface FEF is a part of the first stopper projection 18S1 of the base member 18.

As illustrated in the right-hand view of FIG. 15, when the lens holder 2 moves upward from the neutral state by the predetermined distance DS2, the upper portion UP1 serving as the first movable contact MC1 forming the first stopper ST1 and the ceiling surface CLF serving as the first fixed contact FC1 forming the first stopper ST1 contact each other at a contact surface CTS4 indicated by a dotted circle, thereby restricting further upward movement of the lens holder 2. The upper portion UP1 is a part of the first right-rear elastic portion 7A1, and the ceiling surface CLF is a part of the third corner 1E3 of the spacer 1.

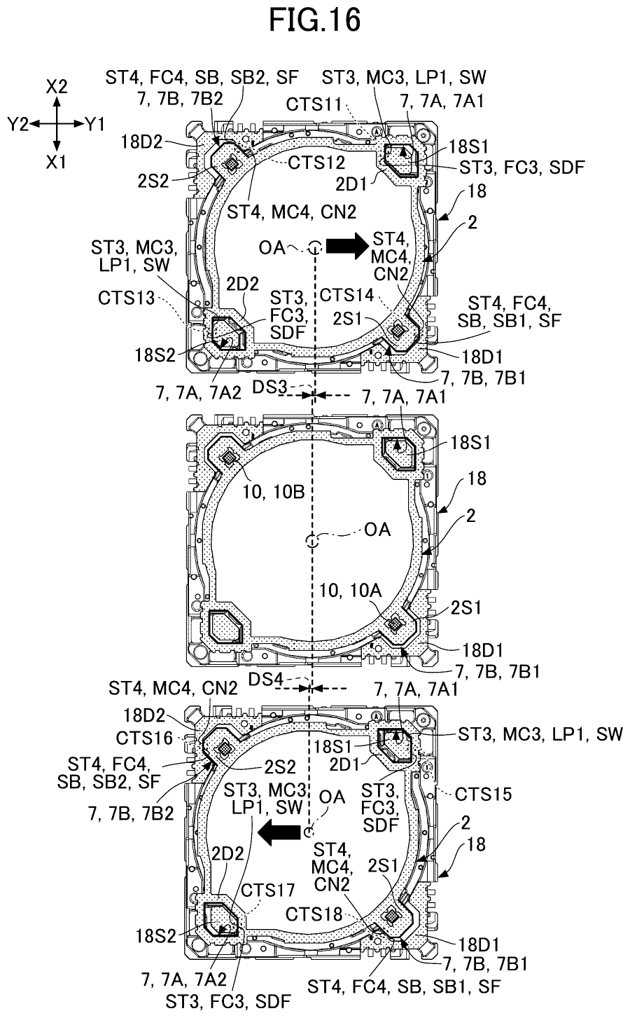

Next, still another example of the state of the lens driving device 101 when the stopper ST functions will be described with reference to FIG. 16. FIG. 16 illustrates a cross-sectional view of the lens holder 2, the elastic portion 7, the first magnetic member 10, the base member 18, and the conductive member CM in a plane parallel to the XY plane including a chain line L3 in the central view of FIG. 14 and a chain line L4 in the center view of FIG. 15. Specifically, the central view of FIG. 16 illustrates the positional relationship of the members in the neutral state, the upper view of FIG. 16 illustrates the positional relationship of the members when the lens holder 2 moves rightward (Y1 side), and the lower view of FIG. 16 illustrates the positional relationship of the members when the lens holder 2 moves leftward (Y2 side). In FIG. 16, the direction of the movement of the lens holder 2 in the Y-axis direction is indicated by a black block arrow.

Specifically, as illustrated in the upper view of FIG. 16, when the lens holder 2 moves rightward from the neutral state by a predetermined distance DS3, the left-hand portion of the inner peripheral surface portion SW serving as the third movable contact MC3 forming the third stopper ST3 and the left-hand portion of the side surface SDF serving as the third fixed contact FC3 forming the third stopper ST3 contact each other at a contact surface CTS11 and a contact surface CTS13 each indicated by a dotted circle, in conjunction with the right-hand portion of the second connection portion CN2 serving as the fourth movable contact MC4 forming the fourth stopper ST4 and the right-hand portion of the inner peripheral surface SF serving as the fourth fixed contact FC4 forming the fourth stopper ST4 contact each other at a contact surface CTS12 and a contact surface CTS14 each indicated by a dotted circle, thereby restricting further rightward movement of the lens holder 2. The inner peripheral surface portion SW is a part of the lower portion LP1 of the first elastic portion 7A, the side surface SDF is a part of the stopper projection 18S of the base member 18, the second connection portion CN2 is a part of the second elastic portion 7B, and the inner peripheral surface SF is a part of the stopper recess SB.

Also, as illustrated in the lower view of FIG. 16, when the lens holder 2 moves leftward from the neutral state by a predetermined distance DS4, the right-hand portion of the inner peripheral surface portion SW serving as the third movable contact MC3 forming the third stopper ST3 and the right-hand portion of the side surface SDF serving as the third fixed contact FC3 forming the third stopper ST3 contact each other at a contact surface CTS15 and a contact surface CTS17 each indicated by a dotted circle, in conjunction with the left-hand portion of the second connection portion CN2 serving as the fourth movable contact MC4 forming the fourth stopper ST4 and the left-hand portion of the inner peripheral surface SF serving as the fourth fixed contact FC4 forming the fourth stopper ST4 contact each other at a contact surface CTS16 and a contact surface CTS18 each indicated by a dotted circle, thereby restricting further leftward movement of the lens holder 2.

The above description made with reference to FIG. 16 relates to the state of the lens driving device 101 when the stopper ST functions as the lens holder 2 moves rightward or leftward from the neutral state. However, the same applies to the state of the lens driving device 101 when the stopper ST functions as the lens holder 2 moves forward or rearward from the neutral state.

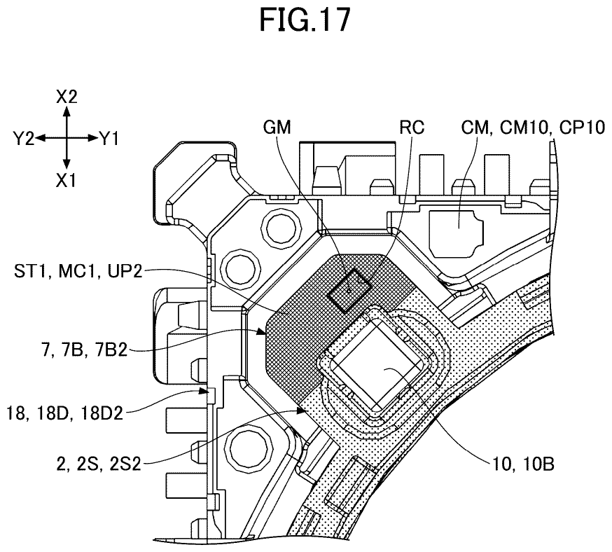

Next, another configuration example of the elastic portion 7 will be described with reference to FIG. 17. FIG. 17 is a top view of the lens holder to which the elastic portion 7 and the first magnetic member 10 are attached, and of the base member 18 in which the conductive member CM is embedded. Specifically, FIG. 17 is an enlarged view of the area R3 enclosed by the broken line illustrated in the upper view of FIG. 13, and corresponds to the lower view of FIG. 13. In FIG. 17, for clarification, the lens holder 2 is shown with a dot pattern, and the elastic portion 7 is shown with a cross pattern.

In the example illustrated in FIG. 17, the elastic portion 7 is integrated with the lens holder 2 through double molding. Specifically, the second left-rear elastic portion 7B2, which is one of the second elastic portions 7B forming the elastic portion 7, is integrated with the second projection 2S2 so as to cover the surfaces (top, side, and bottom surfaces) of the second projection 2S2, and a recess RC is formed at the upper surface of the upper portion UP2. The recess RC is a structure configured to house a gate mark GM, which is a projection formed during double molding. That is, the recess RC is provided such that the upper end of the gate mark GM does not project upward of the upper surface of the upper portion UP2. With this structure, when the lens holder 2 moves upward from the neutral state by the predetermined distance DS2 as illustrated in the right-hand view of FIG. 14, the lens driving device 101 can be prevented from reduction in the maximum amount of upward movement thereof. This reduction is caused by contact of the upper end of the gate mark GM, rather than the upper surface of the upper portion UP2, with the ceiling surface CLF of the spacer 1. The upper portion UP2 is a part of the second left-rear elastic portion 7B2 that functions as the first movable contact MC1 forming the first stopper ST1, and the ceiling surface CLF is a part of the fourth corner 1E4 of the spacer 1 that functions as the first fixed contact FC1 forming the first stopper ST1.

The same applies to the first right-rear elastic portion 7A1, the first left-front elastic portion 7A2, and the second right-front elastic portion 7B1. That is, the recess RC may be provided at the upper surfaces of the upper portion UP1 of the first right-rear elastic portion 7A1 and the first left-front elastic portion 7A2, or may be provided on the upper surfaces of the upper portion UP2 of the second right-front elastic portion 7B1.

Alternatively, the recess RC may be provided at any other portion of the second left-rear elastic portion 7B2, such as, for example, the lower surface of the lower portion LP2 of the second left-rear elastic portion 7B2. The same applies to the first right-rear elastic portion 7A1, the first left-front elastic portion 7A2, and the second right-front elastic portion 7B1.

As described above, the lens driving device 101 according to the embodiment of the present disclosure includes, as illustrated in FIG. 2: the fixed member FB including the base member 18; the lens holder 2 having the cylindrical portion 12 configured to hold the lens body; and the plurality of shape memory alloy wires SA configured to move the lens holder 2 relative to the fixed member FB. As illustrated in FIG. 9, the fixed member FB includes the fixed contact FC forming the stopper ST configured to restrict the movement of the lens holder 2. Also, the lens holder 2 includes the elastic portion 7 formed of the material softer than the synthetic resin material forming the cylindrical portion 12 of the lens holder 2. The elastic portion 7 includes the movable contact MC that faces the fixed contact FC of the stopper ST so as to be able to contact the fixed contact FC of the stopper ST.

With this configuration, the lens driving device 101 can reduce the sound generated upon contact between the fixed contact FC and the movable contact MC, compared to a configuration in which the elastic portion 7 is not provided, e.g., a configuration in which the movable contact MC is formed of the same material as the synthetic resin material forming the cylindrical portion 12 of the lens holder 2. This is because the impact generated upon contact between the fixed contact FC and the movable contact MC is absorbed by the elastic portion 7. As a result, the lens driving device 101 can suppress the generation of abnormal sound. Also, the lens driving device 101 can suppress the generation of foreign matter, such as dust and the like, caused by repeated collisions between the fixed contact FC and the movable contact MC. Such foreign matter is more likely to be generated as the lens body is heavier, but this configuration can suppress the generation of foreign matter even if the lens body is heavier. The lens driving device 101 is mounted on a mobile terminal, such as a smartphone or the like, and collisions between the fixed contact FC and the movable contact MC occur, for example, when a user of the smartphone shakes or drops his or her smartphone.

Also, as illustrated in FIG. 9, the stopper ST may include: the first stopper ST1 configured to restrict the movement of the lens holder 2 toward the subject side (Z1 side); and the second stopper ST2 configured to restrict the movement of the lens holder 2 toward the imaging element side (Z2 side). Further, the elastic portion 7 may include: the first movable contact MC1 that faces the first fixed contact FC1 of the first stopper ST1 so as to be able to contact the first fixed contact FC1 of the first stopper ST1; and the second movable contact MC2 (see also the lower view of FIG. 12) that faces the second fixed contact FC2 (see also the upper view of FIG. 13) of the second stopper ST2 so as to be able to contact the second fixed contact FC2 of the second stopper ST2.

With this configuration, the lens driving device 101 can reduce the sound generated upon contact between the fixed contact FC and the movable contact MC not only when the lens holder 2 moves toward the subject side (Z1 side) but also when the lens holder 2 moves toward the imaging element side (Z2 side).

The first movable contact MC1 and the second movable contact MC2 may be continuously formed integrally as illustrated in FIG. 12, or may be formed as separate and independent members.

The configuration in which the first movable contact MC1 and the second movable contact MC2 are integrated provides the effect of increasing dimensional accuracy of the first movable contact MC1 and the second movable contact MC2, compared to the configuration in which the first movable contact MC1 and the second movable contact MC2 are formed as separate members. Also, when the elastic portion 7 is formed through double molding, the integrated configuration provides the effect of increasing productivity compared to the configuration in which the elastic portion 7 is formed as separate members.

Also, as illustrated in the upper view of FIG. 12, the movable base 2D of the lens holder 2 may include the upper wall UW through which the penetrating portion TH penetrates in the optical axis direction. In this case, the elastic portion 7 (first elastic portion 7A) may include the first connection portion CN1 disposed in the penetrating portion TH. The first movable contact MC1 and the second movable contact MC2 may be connected by the first connection portion CN1. The first movable contact MC1 may be disposed in contact with the upper surface of the upper wall UW, and the second movable contact MC2 may be disposed in contact with the lower surface of the upper wall UW (ceiling surface (inner bottom surface IBF of the stopper recess CV (see the upper view of FIG. 11)). Also, as illustrated in the upper view of FIG. 12, the elastic portion 7 (first elastic portion 7A) may be configured such that a width WD0 (maximum width) of the first connection portion CN1 in a cut plane perpendicular to the optical axis OA is smaller than a width WD1 (maximum width) of the first movable contact MC1 and smaller than a width WD2 (maximum width) of the second movable contact MC2. The width WD0, the width WD1, and the width WD2 are all widthwise dimensions in the tangential direction of a circle having the optical axis OA as the center thereof. In other words, the elastic portion 7 (first elastic portion 7A) may be configured such that the cross sections of the upper portion UP1 and the lower portion LP1 (ceiling surface CW) are larger than the cross section of the first connection portion CN1, and as a result, the upper portion UP1 and the lower portion LP1 cannot pass through the penetrating portion TH. That is, the first connection portion CN1 may be a narrow portion narrower than the upper portion UP1 positioned on the upper side thereof and the lower portion LP1 (ceiling surface CW) positioned on the lower side thereof.

This configuration provides the effect of being able to prevent the elastic portion 7 (first elastic portion 7A) from coming off the lens holder 2, compared to the configuration in which the cross section of the first connection portion CN1 is larger than the cross section of the upper portion UP1 or the lower portion LP1. Also, this configuration provides the effect that the elastic portion 7 (first elastic portion 7A) can be readily integrated with the lens holder 2 through double molding. Also, this configuration provides the effect of being able to widen a portion of the upper portion UP1 that functions as the first movable contact MC1, compared to the cross section of the first connection portion CN1, while reducing the amount of materials used.

Also, as illustrated in the upper view of FIG. 3, the lens holder 2 may include a pair of movable bases 2D that project outward from the cylindrical portion 12. In this case, the pair of movable bases 2D may be disposed at positions facing each other across the optical axis OA. The movable metal member 5M to which one end of the shape memory alloy wire SA is to be fixed may be fixed to each of the pair of movable bases 2D. Also, as illustrated in the upper view of FIG. 11, the pair of movable bases 2D may each be formed into a recess opened downward, and may include the cylindrical wall TW. In this case, the upper wall UW in which the penetrating portion TH is formed may be positioned so as to connect the upper portions of the cylindrical wall TW. Also, as illustrated in FIG. 9, the base member 18 may include the base portion 18B and a pair of stopper projections 18S that project upward from the base portion 18B. In this case, the pair of stopper projections 18S may be disposed at positions facing each other across the optical axis OA. Also, the pair of stopper projections 18S may each be disposed in the cylindrical wall TW of each of the pair of movable bases 2D in the neutral state of the lens driving device 101. Also, the end surface FEF of each of the pair of stopper projections 18S may form the second fixed contact FC2 of the second stopper ST2. Also, the side surface SDF of each of the pair of stopper projections 18S may form the third fixed contact FC3 of the third stopper ST3 configured to restrict the movement of the lens holder 2 in the direction crossing the optical axis direction. As illustrated in the upper view of FIG. 12, the elastic portion 7 (first elastic portion 7A) may include: the ceiling surface CW provided at the lower surface of the upper wall UW (inner bottom surface IBF that is the ceiling surface of the stopper recess CV (see the upper view of FIG. 11)); and an inner peripheral surface portion SW provided at the inner peripheral surface IF of the cylindrical wall TW (see the lower view of FIG. 11). In this case, as illustrated in the lower view of FIG. 12, the ceiling surface CW may form the second movable contact MC2 that faces the second fixed contact FC2 (see FIG. 9) so as to be able to contact the second fixed contact FC2, and the inner peripheral surface portion SW may form the third movable contact MC3 that faces the third fixed contact FC3 (see FIG. 9) so as to be able to contact the third fixed contact FC3. The second movable contact MC2 and the third movable contact MC3 may be continuously formed integrally.

With this configuration, when the lens holder 2 moves in the direction crossing the optical axis direction (e.g., in the X-axis or Y-axis direction), when the lens holder 2 rotates about the optical axis OA, or when the lens holder 2 moves in a combined manner of them, the lens driving device 101 can reduce the sound generated upon contact between the third fixed contact FC3 and the third movable contact MC3. As a result, the lens driving device 101 can suppress the generation of abnormal sound.

As illustrated in the lower view of FIG. 12, the inner peripheral surface portion SW may be provided over the entire region of the inner peripheral surface IF of the cylindrical wall TW. That is, as illustrated in the lower view of FIG. 12, the inner peripheral surface portion SW may be provided so as to cover each of the six planes forming the inner peripheral surface IF of the cylindrical wall TW.

This configuration provides the effect that the elastic portion 7 (first elastic portion 7A) is less likely to be peeled off from the inner peripheral surface IF, compared to the case in which the inner peripheral surface portion SW is provided to cover only a part of the inner peripheral surface IF of the cylindrical wall TW.

Also, as illustrated in FIG. 12, the lens holder 2 may include a pair of projections 2, projecting outward from the cylindrical portion 12, at positions facing each other across the optical axis OA. In this case, the elastic portion 7 (second elastic portion 7B) may include: the first movable contact MC1 (upper portion UP2) provided at the upper surface of the projection 2S; the second movable contact MC2 (lower portion LP2) provided at the lower surface of the projection 2S; and the second connection portion CN2 provided at the side surface of the projection 2S and connecting the first movable contact MC1 and the second movable contact MC2.

This configuration provides the effect that the elastic portion 7 (second elastic portion 7B) can be prevented from coming off from the lens holder 2, compared to the configuration in which the first movable contact MC1 and the second movable contact MC2 are formed as separate members. Also, this configuration provides the effect that the elastic portion 7 (second elastic portion 7B) can be readily integrated with the lens holder 2 through double molding.

As illustrated in FIG. 9, the base member 18 may include the base portion 18B and the pair of outer walls (fixed bases 18D) disposed so as to cover the outer portions of the pair of projections 2S. Also, the outer wall (fixed base 18D) may form the fourth fixed contact FC4 of the fourth stopper ST4 configured to restrict the movement of the lens holder 2 in the direction crossing the optical axis direction (e.g., in the X-axis or Y-axis direction). In this case, as illustrated in FIG. 12, the second connection portion CN2 of the second elastic portion 7B may form the fourth movable contact MC4 that is formed continuously with the outer surface of the projection 2S and faces the fourth fixed contact FC4 so as to be able to contact the fourth fixed contact FC4. Also, as illustrated in the lower view of FIG. 3, a fixed metal member 5F to which the other end of the shape memory alloy wire is to be fixed may be fixed to the outer surface of the outer wall (fixed base 18D).

With this configuration, when the lens holder 2 moves in the direction crossing the optical axis direction (e.g., in the X-axis or Y-axis direction), when the lens holder 2 rotates about the optical axis OA, or when the lens holder 2 moves in a combined manner of them, the lens driving device 101 can reduce the sound generated upon contact between the fourth fixed contact FC4 and the fourth movable contact MC4. As a result, the lens driving device 101 can suppress the generation of abnormal sound.

Also, as illustrated in FIG. 9, the fixed member FB may include: the cover member 4 (upper cover member 4U) that includes the outer peripheral wall (first outer peripheral wall 4A) and the upper plate 4B and is fixed to the base member 18 with the lens holder 2 being housed therein; and the synthetic resin spacer 1 that is disposed between the lens holder 2 and the upper plate 4B and is fixed to the cover member 4 (upper cover member 4U). In this case, the first fixed contact FC1 of the first stopper ST1 may be provided at the spacer 1.

This configuration provides the effect of being able to avoid direct contact of the elastic portion 7, functioning as the first movable contact MC1, with the cover member 4 (upper cover member 4U). Therefore, this configuration provides the effect of being able to avoid possible disadvantages caused by direct contact between the cover member 4 (upper cover member 4U) and the elastic portion 7 regardless of whether the cover member 4 (upper cover member 4U) is formed of a metal or a synthetic resin.

The elastic portion 7 may be integrated with the lens holder 2 through double molding. In this case, as illustrated in FIG. 17, the gate mark GM formed during the double molding may be in the recess RC at the movable contact MC.

This configuration provides the effect of being able to prevent reduction in the maximum amount of upward movement of the lens holder 2. This reduction is caused by contact of the upper end of the gate mark GM, rather than the upper surface of the upper portion UP2 functioning as the first movable contact MC1 of the first stopper ST1, with the ceiling surface CLF of the spacer 1 functioning as the first fixed contact FC1 of the first stopper ST1 when the lens holder 2 moves upward from the neutral state by the predetermined distance DS2 as illustrated in the right-hand view of FIG. 14.

The embodiments of the present invention have been described in detail. However, the present invention is not limited to the above-described embodiments. Various modifications, substitutions, and the like are applicable to the above-described embodiments without departing from the scope of the present invention. Also, the features described with reference to the above-described embodiments may be appropriately combined as long as there is no technical contradiction.

The lens driving device described above can suppress the generation of the sound at the stopper.

What is claimed is:

1. A lens driving device, comprising:
a fixed member including a base member;
a lens holder including a cylindrical portion configured to hold a lens body; and
a plurality of shape memory alloy wires configured to move the lens holder with respect to the fixed member,
the fixed member including
a fixed contact that forms a stopper configured to restrict movement of the lens holder,
the lens holder including
an elastic portion formed of a material that is softer than that of a synthetic resin material forming the cylindrical portion of the lens holder, and
the elastic portion including
a movable contact that faces the fixed contact of the stopper so as to be able to contact the fixed contact of the stopper.

2. The lens driving device according to claim 1, wherein
the stopper includes
a first stopper configured to restrict the movement of the lens holder toward a subject side, and
a second stopper configured to restrict the movement of the lens holder toward an imaging element side,
the elastic portion includes
a first movable contact that faces a first fixed contact of the first stopper so as to be able to contact the first fixed contact of the first stopper, and
a second movable contact that faces a second fixed contact of the second stopper so as to be able to contact the second fixed contact of the second stopper.

3. The lens driving device according to claim 2, wherein
the first movable contact and the second movable contact are continuously formed integrally.

4. The lens driving device according to claim 3, wherein
the lens holder includes
an upper wall through which a penetrating portion penetrates in a direction of an optical axis,
the elastic portion includes
a first connection portion disposed in the penetrating portion,
the first movable contact and the second movable contact are connected by the first connection portion,
the first movable contact is disposed in contact with an upper surface of the upper wall,
the second movable contact is disposed in contact with a lower surface of the upper wall, and
a width of the first connection portion in a cut plane thereof perpendicular to the optical axis is smaller than that of the first movable contact and smaller than that of the second movable contact.

5. The lens driving device according to claim 4, wherein
the lens holder includes
a pair of movable bases that project outward from the cylindrical portion,
the pair of movable bases are disposed at positions facing each other across the optical axis,
a movable metal member to which one end of the shape memory alloy wires is fixed to each of the pair of movable bases,
each of the pair of movable bases is formed into a recess opened downward, and includes a cylindrical wall,
the upper wall through which the penetrating portion penetrates is positioned so as to connect upper portions of the cylindrical wall,
the base member includes a base portion and a pair of stopper projections that project upward from the base portion,
the pair of stopper projections are disposed at positions facing each other across the optical axis,
the pair of stopper projections are each disposed in the cylindrical wall of each of the pair of movable bases,
an end surface of each of the pair of stopper projections forms the second fixed contact of the second stopper,
a side surface of each of the pair of stopper projections forms a third fixed contact of a third stopper configured to restrict the movement of the lens holder in a direction crossing the direction of the optical axis,
the elastic portion includes
a ceiling surface provided at the lower surface of the upper wall, and
an inner peripheral surface portion provided at an inner peripheral surface of the cylindrical wall,
the ceiling surface forms the second movable contact that faces the second fixed contact so as to be able to contact the second fixed contact,
the inner peripheral surface portion forms a third movable contact that faces the third fixed contact so as to be able to contact the third fixed contact, and
the second movable contact and the third movable contact are continuously formed integrally.

6. The lens driving device according to claim 5, wherein
the inner peripheral surface portion is provided over an entire region of the inner peripheral surface of the cylindrical wall.

7. The lens driving device according to claim 2, wherein
the lens holder includes
a pair of projections at positions facing each other across an optical axis, the pair of projections projecting outward from the cylindrical portion,
the elastic portion includes
the first movable contact provided at upper surfaces of the projections,
the second movable contact provided at lower surfaces of the projections, and
a second connection portion that is provided at side surfaces of the projections and connects the first movable contact and the second movable contact.

8. The lens driving device according to claim 7, wherein
the base member includes
a base portion, and
a pair of outer walls disposed so as to cover an outer portion of the pair of projections,
the outer walls form a fourth fixed contact of a fourth stopper configured to restrict the movement of the lens holder in a direction crossing a direction of an optical axis, and
the second connection portion is formed continuously with an outer surface of the pair of projections, and forms a fourth movable contact that faces the fourth fixed contact so as to be able to contact the fourth fixed contact.

9. The lens driving device according to claim 2, wherein
the fixed member includes
a cover member that includes an outer peripheral wall and an upper plate and is fixed to the base member with the lens holder being housed therein, and
a synthetic resin spacer that is disposed between the lens holder and the upper plate and is fixed to the cover member, and
the first fixed contact of the first stopper is provided at the spacer.

10. The lens driving device according to claim 1, wherein
the elastic portion is integrated with the lens holder through double molding, and
a gate mark formed upon the double molding is in a recess at the movable contact.

11. A camera module, comprising:
the lens driving device of claim 1;
the lens body; and
an imaging element facing the lens body.

12. A camera module, comprising:
the lens driving device of claim 2;
the lens body; and
an imaging element facing the lens body.

13. A camera module, comprising:
the lens driving device of claim 3;
the lens body; and
an imaging element facing the lens body.

14. A camera module, comprising:
the lens driving device of claim 4;
the lens body; and
an imaging element facing the lens body.

15. A camera module, comprising:
the lens driving device of claim 5;
the lens body; and
an imaging element facing the lens body.

16. A camera module, comprising:
the lens driving device of claim 6;
the lens body; and
an imaging element facing the lens body.

17. A camera module, comprising:
the lens driving device of claim 7;
the lens body; and
an imaging element facing the lens body.

18. A camera module, comprising:
the lens driving device of claim 8;
the lens body; and
an imaging element facing the lens body.
